(19) United States
(12) Patent Application Publication
(10) Pub. No.: US 2002/0019836 A1
(43) Pub. Date: Feb. 14, 2002

(54) Information processing apparatus for management of documents relevant to patent application

(76) Inventors: Hirokazu Uchio, Tokyo (JP); Tomoyuki Kaneda, Kanagawa (JP); Satoru Motohasi, Chiba (JP)

Correspondence Address: ROBIN BLECKER & DALEY, 2ND FLOOR, 330 MADISON AVENUE, NEW YORK, NY, 10017, US

(21) Appl. No.: 09/852,563

(22) Filed: May 10, 2001

(30) Foreign Application Priority Data
May 16, 2000 (JP) 143053-2000
May 16, 2000 (JP) 143054-2000
May 16, 2000 (JP) 143352-2000
May 16, 2000 (JP) 143354-2000

(51) Int. Cl. G06F 15/00

(52) U.S. Cl. 707/511; 707/203

(57) ABSTRACT

To provide an information processing apparatus for efficiently managing documents and various procedures related to a patent application. Information related to a patent application is accumulated in a database for each case, and managed for due date. When an inventor has to study a case, a request to study the case is issued to the inventor through a network, and the state of the study by the inventor is checked through the network. Furthermore, related prior art is managed in a database, thereby efficiently filing an application with Patent Office.

### BACKGROUND OF THE INVENTION

1. Field of the Invention

The present invention relates to an information processing apparatus, an information processing method, and a program storage medium, and more specifically to an information processing apparatus, an information processing method, and a program storage medium having the function of managing documents.

2. Related Background Art

Recently, an increasing number of patent-related documents have been stored and processed as electronic data. The data are normally transmitted and received using IT technology in issuing the publication of Patent Office using CD-ROM as a medium, storing registration publications as electronic data, filing an application with Patent Office through a network, receiving documents from Patent Office, etc.

Furthermore, a retrieval system, publication of various information, etc. have been widely performed through Internet.

On the other hand, enterprises have designed their own computer systems for managing their intellectual property such as patents, utility models, etc. In most of the systems, data of bibliographic information such as the filing date, the application number, etc. for a patent is managed mainly by databases, etc., retrieved, and displayed for necessary term management, etc.

However, the above mentioned documents stored as electronic data, and the progress in a network environment have required electronic management also on the document format, that is, the text of documents to be submitted to Patent Office. Therefore, not only the normal term management, but also the proposal from an inventor, the application and the relevant documents for communications with Patent Office through a network with an attorney have to be appropriately managed.

However, if documents are generated through the above mentioned network, and a person in charge of performing the check and approval processes does not correctly recognize the processes, then the processes often remain unfulfilled. Especially in case of a document having a prescribed term such as a reply to Patent Office, a severe problem can occur.

On the other hand, to effectively generate these documents, it is necessary to establish a document checking system using an in-house network.

It is also necessary to effectively check and approve a predetermined case through the network.

Furthermore, in a paperless environment, it is necessary to efficiently store reference documents in a notice of reasons for rejection in a database and retrieve them therefrom.

### SUMMARY OF THE INVENTION

The present invention has been developed to solve the above mentioned problems, and aims at providing an information processing apparatus, an information processing method, and a program storage medium capable of efficiently studying a specific case through a network.

The present invention also aims at providing an information processing apparatus, an information processing method, and a program storage medium capable of efficiently managing intellectual property.

To solve the above mentioned problems, the information processing apparatus according to the present invention studies a target case by communicating information through a network, and includes: request means for requesting a study of the target case in a first staff for the study; and detection means for detecting access by the first staff for the study to a database relating to the target case.

Furthermore, the information processing apparatus according to the present invention studies a target case by communicating information through a network, and includes: a table containing organization information; and management means for selectively performing, by referring to the table, a first study management mode for study of the target case through a predetermined path and a second study management mode for the staff for the study of the target case sequentially requesting subsequent staffs for the study of the target case.

The information processing apparatus according to the present invention generates a document relating to a patent application by communicating information through a network, and includes: associating means for dividing a patent application procedure into a plurality of steps, and associating reference documents used in generating the document in the step units with the due date of the generation of the document; and management means for managing the generation of the document.

The information processing apparatus according to the present invention accumulates technical documents relating to a patent application, and includes: accumulation means for accumulating related technical documents including counterpart foreign applications; and display control means for listing the technical documents of patent applications accumulated in the accumulation means.

Another aspect of the present invention will be clear by the descriptions of the detailed explanation and the claims described below.

### BRIEF DESCRIPTION OF THE DRAWINGS

FIG. 1 shows a typical configuration of the intellectual property management system according to an embodiment of the present invention;

FIG. 2 shows a flow of information in the intellectual property management system;

FIG. 3 shows an example of an organization in an intellectual property right acquirement section 105, a development right acquirement support section 103, and a research and development section 102;

FIG. 4 shows a method for managing a database in an embodiment of the present invention;

FIG. 5 shows a concept of an action case;

FIG. 6 shows an application case for generating an application document;

FIG. 7 shows a rejection reason response case in which a response to a rejection reason is issued;

FIG. 8 shows a final rejection decision response case in which a response to a decision of a final rejection is issued;

FIG. 9 shows an example of an action study path in an organization configuration as shown in FIG. 3;

FIG. 10 shows an example of an approval path of an action study result;

FIG. 11 shows a table of an action study approval path pattern shown in FIG. 9 and FIG. 10;

FIG. 12 shows a pattern selection table for freely setting a work flow by section (3) and by staff of intellectual property right acquirement section (4) using a pattern table shown in FIG. 11;

FIG. 13 is a flowchart showing the setting of a flow of an action case;

FIG. 14 shows the document follow-up function for an action case;

FIG. 15 is a flowchart of the document follow-up process;

FIG. 16 shows the action case copy function;

FIG. 17 practically shows the method of using a copy case;

FIG. 18 shows an example of an information transmission method in a development section;

FIG. 19 is a flowchart of the invoice process from the intellectual property related office according to the present system;

FIG. 20 shows the typical configuration of the intellectual property management system according to the second embodiment of the present invention;

FIG. 21 shows an example of an OA machines and devices provided for the intellectual property right acquirement support section 106;

FIG. 22 shows a cover page of facsimile;

FIG. 23 is a flowchart of the flow of the process of receiving facsimile;

FIG. 24 is a flowchart of the flow of the process of receiving facsimile;

FIG. 25 shows the configuration of the display screen for a user confirming the process status of an action case;

FIG. 26 shows the configuration of the display screen for a user confirming the process status of an action case;

FIG. 27 is a flowchart showing the method of inputting data into a system when documents are transmitted through a paper medium by facsimile;

FIG. 28 is a flowchart showing the method of inputting data into a system when documents are transmitted through a paper medium by facsimile;

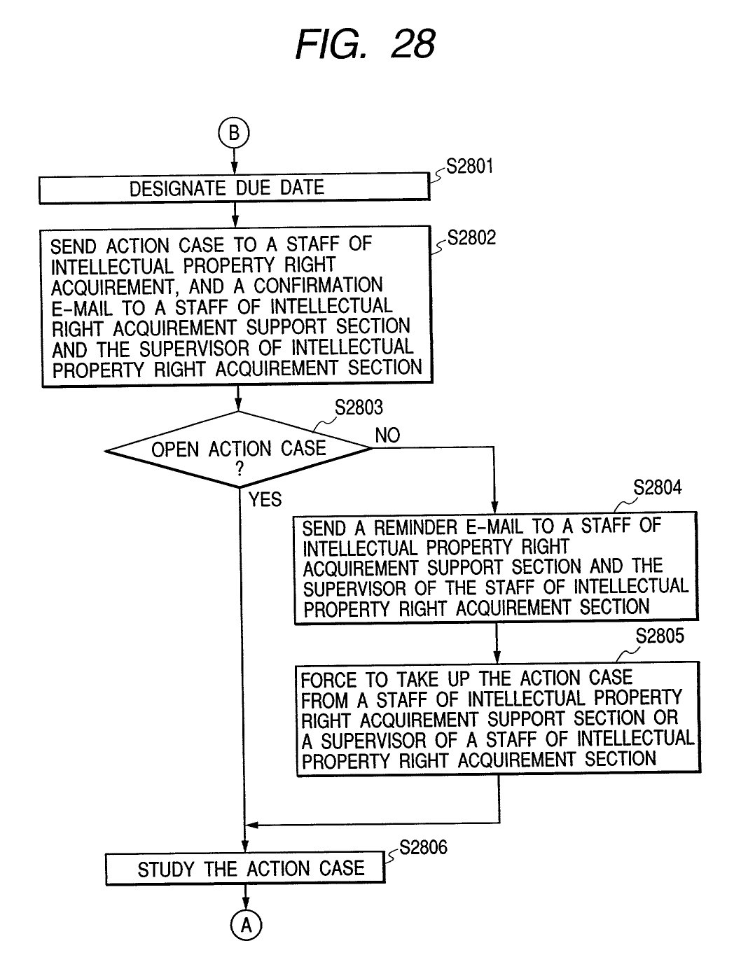

FIG. 29 shows a display screen of a client PC for explanation of a method of using a cited document database designed in the server 118;

FIG. 30 shows a display screen of a client PC for explanation of a method of using a cited document database designed in the server 118;

FIG. 31 shows a display screen of a client PC for explanation of a method of using a cited document database designed in the server 118;

FIG. 32 shows a display screen of a client PC for explanation of a method of using a cited document database designed in the server 118;

FIG. 33 shows a display screen of a client PC for explanation of a method of using a cited document database designed in the server 118;

FIG. 34 describes the definition of a DB management item in designing a database;

FIG. 35 describes the definition of a DB management item in designing a database; and

FIG. 36 describes the definition of a DB management item in designing a database.

### DETAILED DESCRIPTION OF THE PREFERRED EMBODIMENTS

### First Embodiment

The first embodiment of the present invention is described below by referring to the attached drawings.

### Entire Configuration of Intellectual Property Management System

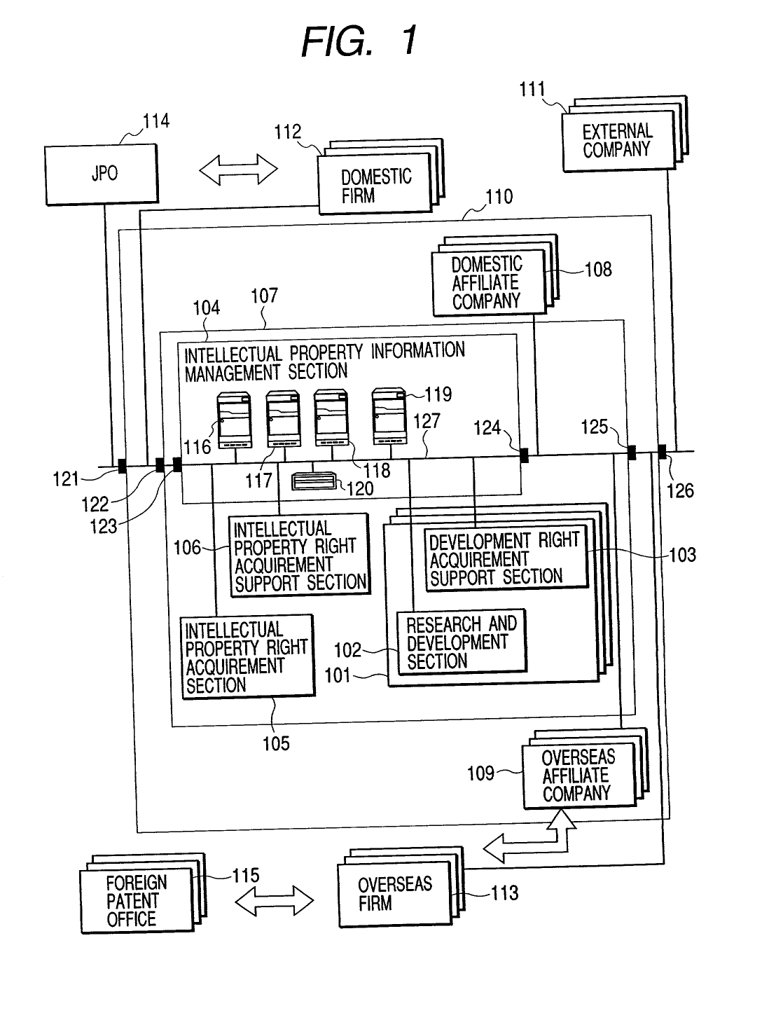

FIG. 1 shows the typical configuration of the intellectual property management system according to the present embodiment.

In FIG. 1, reference numeral 107 denotes the head office of an enterprise performing economic activities such a research, development, production, sales, etc., and includes a section for managing the intellectual property such as a patent, etc.

Reference numeral 104 denotes an intellectual property information management section including a document server 116, a management server 117, servers 118, 119, 120, etc.

The document server 116 includes a document DB (database) for management of a file wrapper, etc. containing the electronically generated documents, a series of documents generated in the communications between server 116 and Patent Office. The management server 117 contains bibliographic information such as an application number, a patent number, a filing date, a registration date, etc., and a management DB for management of the term of the office action of Patent Office. The server 118 contains a general purpose DB storing a specific publication of Japanese Patent Office, US. Patent Office, etc., and related information. The server 119 configures an application system for management of a work flow described later, and other database (for example, a database of cited documents). The server 120 integrally manages the document servers 116 to 119, and controls the entire intellectual property information management system. In the embodiment described below, a ‘system’ refers to a system managed by the server 120.

These components are all connected to a basic network 127. Each of the above mentioned components of the intellectual property information management section 104 can be realized by the same computer machine.

A document stored in the document server 116 can be normal text documents, drawings stored as normal image information, mixed mode documents containing both text and images, documents in the format unique to a word processor, etc. The electronic documents used in the communications with Patent Office and in-house documents are stored in a document database of the document server 116 by the application system of the server 119. Normally, the document database is assigned a number identifying the document, and linked to the management database of bibliographic items in the management server 117.

Reference numeral 105 denotes an intellectual property right acquirement section for acquiring the right of the intellectual property by transmitting and receiving documents directly to and from Patent Office.

Reference numeral 106 denotes an intellectual property right acquirement support section for supporting the acquirement of the right of an electronic patent application original, term management, etc.

Reference numeral 101 is a section for research and development including a research and development section 102 and a development right acquirement support section 103 for supporting the acquirement of the right of developed intellectual property.

The intellectual property right acquirement section 105 and the intellectual property right acquirement support section 106 have the routine of inputting information and generating documents about intellectual property, and can operate an exclusive application screen of a client PC in principle.

On the other hand, the research and development section 102 normally performs research and development, and incidentally performs the operations related to the intellectual property. Therefore, it accesses the servers 116 to 119 of the in-house intellectual property information management section 104 through an in-house network, displays a Web screen, and performs a necessary process. A corresponding staff can be notified of the timing of opening the Web screen through in-house electronic mail.

Reference numeral 108 denotes a plurality of domestic affiliate companies located in Japan. Reference numeral 109 denotes a plurality of overseas affiliate companies located overseas. They can communicate with each other with the security guaranteed through a dedicated line (electronic mail, facsimile communications, etc. using a specified transmission path of data on transmission and reception sides).

Reference numeral 110 denotes an enterprise group comprising the head office 107, the domestic affiliate companies 108, and the overseas affiliate companies 109.

Reference numeral 111 denotes a plurality of external companies for cooperatively perform research and development with the enterprise group 110. They manage the products of the cooperative research and development based on the mutual contract, and acquire a patent right. The system can transmit and receive data through Internet.

Reference numeral 112 denotes a plurality of domestic firms related to intellectual property located in Japan. Reference numeral 113 denotes a plurality of overseas firms related to intellectual property. They can communicate with each other through the above mentioned dedicated line or Internet.

Reference numeral 114 denotes Japanese Patent Office (JPO) to which the above mentioned system is connected through an online terminal. In the present embodiment, it refers to Japanese Patent Office, but it refers to USPTO in the U.S.

Reference numeral 115 denotes a plurality of foreign patent offices with which the enterprise group 110 performs a procedure in writing through the overseas firm 113.

Each of the above mentioned sections has a plurality of terminal PCs, etc. used for inputting/outputting information or the like. A staff of each section has his or her ID and password, and can access the above mentioned system.

Each section has a plurality of client computers connected through a network, displays data of the servers 116 to 120, and prints the data of the servers 116 to 120 in a specified format on a printer. The client computer has a scanner for inputting an image as necessary.

In the present system, the amount of outgoing information is managed in plural steps. For example, between 123 and 124, that is, in the intellectual property information management section, high-level information is concentrated, and is freely distributed. Therefore, it is necessary to place a strict restriction on the outgoing information therefrom both in quantity (quantity of information) and quality (type of information).

Furthermore, between 122 and 125, that is, in the head office, the scope of the distribution of information is large. Therefore, the flow of information is limited by, for example, the prohibition of inspection outside each section so that a large amount of high-level information cannot be distributed to a specific section. Between 121 and 126, that is, in a group company, the scope of the distribution of information is enlarged. Therefore, the amount and quality of the outgoing information to each section is furthermore restricted.

On the other hand, about the security check, the level of the security check depends on the amount and quality of the distributed information, and the level of the risk of the outgoing information.

### Flow of Information in Intellectual Property Management System

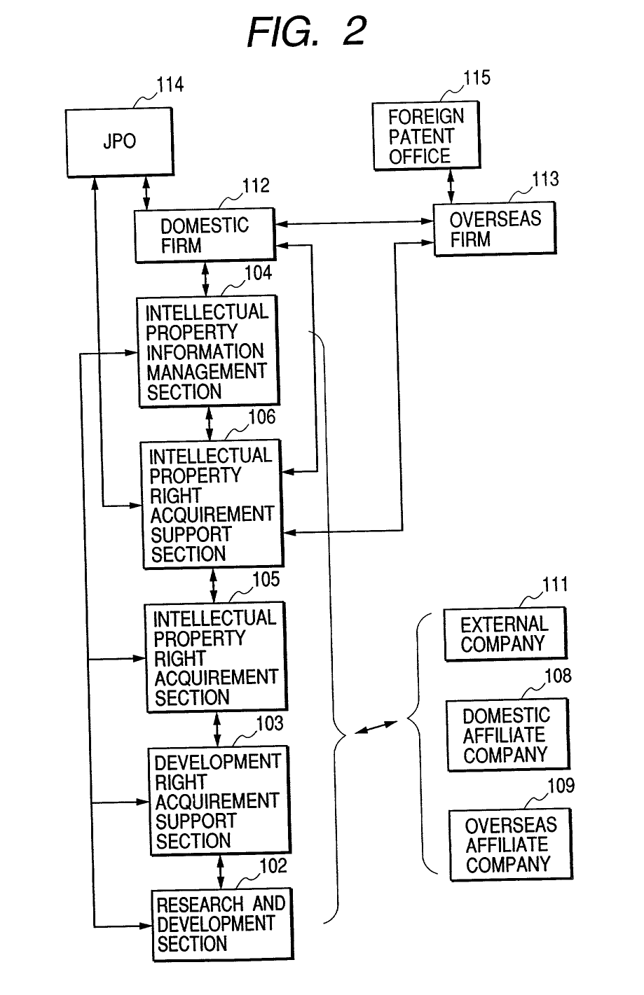

FIG. 2 shows the flow of information in the above mentioned intellectual property management system.

Documents and data are transmitted and received between the JPO 114 and the domestic firm 112 or the intellectual property right acquirement support section 106.

The overseas firm 113 communicates documents and data with the foreign patent office 115. The overseas firm 113 communicates documents and data with the domestic firm 112 or the intellectual property right acquirement support section 106. The electronic information transmitted from the overseas firm 113 is registered in the system of the intellectual property information management section 104 as necessary.

The intellectual property information management section 104 provides information for the intellectual property right acquirement support section 106, the intellectual property right acquirement section 105, the development right acquirement support section 103, and the research and development section 102 as necessary, and registers the information from each section in the system.

An external company 111, the domestic affiliate company 108, and the overseas affiliate company 109 communicates documents and data with each section in the head office 107 as necessary.

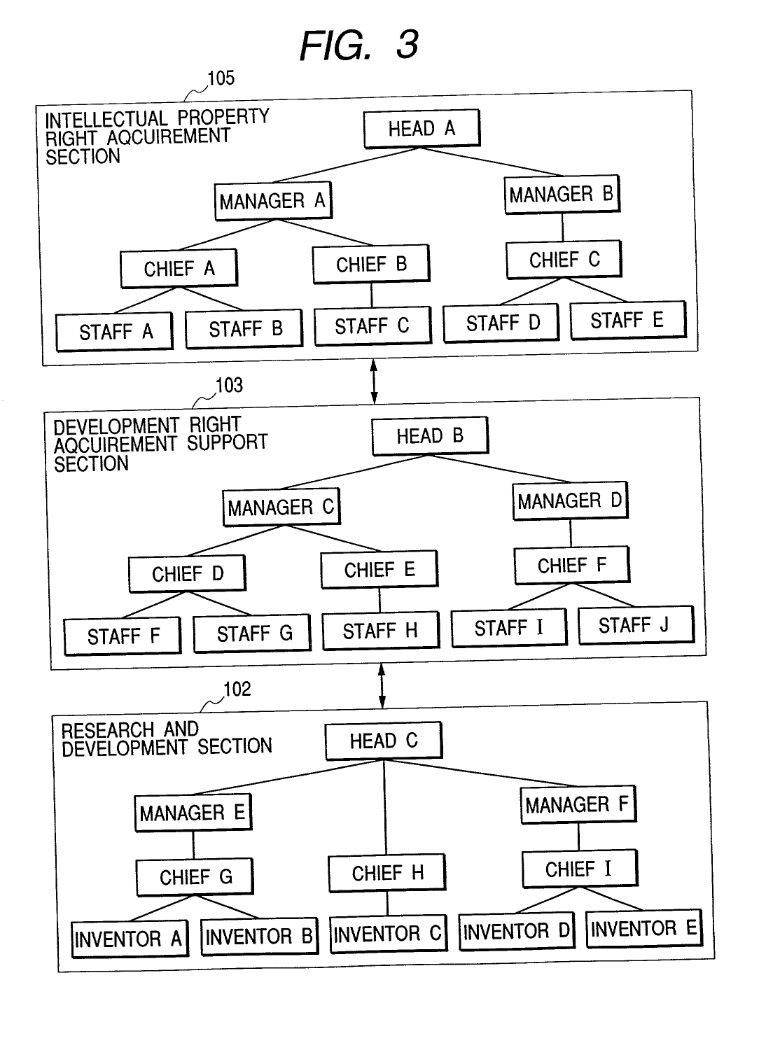

FIG. 3 shows an example of the organization of the intellectual property right acquirement section 105, the development right acquirement support section 103, and the research and development section 102.

For example, the intellectual property right acquirement section 105 has an organization in which a chief A is the boss of staffs A and B, a chief B is the boss of a staff C, a chief C is the boss of staffs D and E, a manager A is the boss of the chiefs A and B, a manager B is the boss of the chief C, and a head A is the boss of the managers A and B.

Similarly, the development right acquirement support section 103 has an organization in which a chief D is the boss of staffs F and G, a chief E is the boss of a staff H, a chief F is the boss of staffs I and J, a manager C is the boss of the chiefs D and E, a manager D is the boss of the chief F, and a head B is the boss of the managers C and D.

Furthermore, the research and development section 102 has an organization in which a chief G is the boss of inventors (developers) A and B, a chief H is the boss of an inventor (developer) C, a chief I is the boss of inventors (developers) D and E, a manager E is the boss of a chief of the chief G, a manager F is the boss of the chief I, and a head C is the boss of the managers E and F.

In this system, the staffs of the organization is associated with the configuration of the organization, and are stored with staff codes (ID numbers of the employees) in the table of the server 119.

By storing the above mentioned organization information as a table in the system, for example, the destination of a document (mail) can be automatically set to acquire the approval of a boss, thereby checking whether there is an error in the transfer of the document addressed to a plurality of destinations in different orders. Thus, users can more easily use the functions of the system.

On the other hand, the above mentioned organization information has to be periodically updated to maintain correct information, and the maintenance is a heavy load to a user. Whether or not such organization information is to be stored in the system can be determined, for example, by each section. It is desired that the information is stored in the system for a section in which there is a small change in the information, and for a section in which the system is allowed to be more easily used by updating the information each time a change is made with the load of the maintenance taken into account.

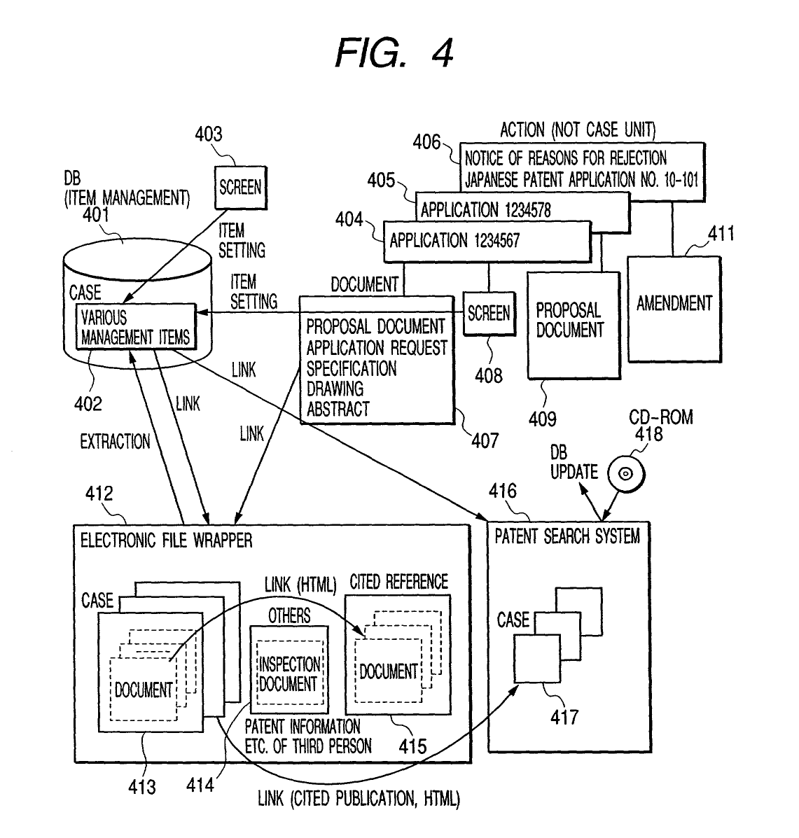

FIG. 4 shows the method for managing a database according to the present embodiment.

In FIG. 4, reference numeral 401 denotes a management DB contained in the management server 117. In this DB, various management items 402 are stored in case (application) units. A management item can be set by a staff of the intellectual property information management section on a screen 403 of the client PC.

Reference numerals 404 to 406 denote units of generating a document about each case. The unit is referred to as an ‘action’ in the present embodiment. In generating a document, a virtual file case in the system is defined as an ‘action case’.

For example, documents 407 such as a proposal document, an application request, a specification, drawings, an abstract, etc. are generated for an in-house suggestion on an invention for the action 404 which refers to the application of the management number 1234567. On a screen 408 of the client PC, the management data incident to the application such as a filing date, an inventor, etc. are confirmed. The documents 407 are registered in an electronic file wrapper 412 described later formed in the document server 116, and the management data for the latter is registered in the management DB 401 corresponding to the management item 402.

When a user (a developer, a staff) requests to display the action case, the management DB 401 is accessed for a management item. The documents 407 can be displayed by a link to the electronic file wrapper 412.

Since an application document has not been generated (prepared) for an action 405 of the application of the management number 12345678, only a proposal document 409 has been registered in the system.

An amendment 411 has been registered for the action 406, that is, a notice of reasons for rejection, for the Japanese Patent Application No. 10-101.

Other actions can be processes for legal procedures such as a decision of final rejection, a declinement of amendment, a lodgement of opposition, a request for examination, a response for invitation for correction, etc.

Furthermore, the contents of the electronic file wrapper 412 formed in the document server 116 can be a document 413 for each case, an inspection document 414 such as the patent information of third parties, a cited document 415 referenced in an examination by Patent Office for a case. However, the cited document 415 can be stored in a DB on another server 119 as described above, and can be easily retrieved on the screen for access to the case through the link of the HTML.

A link is established from the management DB 401 to the electronic file wrapper 412, and necessary data can be extracted from a document registered in the electronic file wrapper 412, and then be registered in the management DB 401. A link is established from the management DB 401 and the electronic file wrapper 412 to a patent search system 416 formed by the server 118 such that a case 417 in the patent search system 416 can be easily accessed from a document in the electronic file wrapper 412.

The information in the patent search system 416 can be DB-updated through a medium 418 such as CD-ROM, etc.

### Action Case

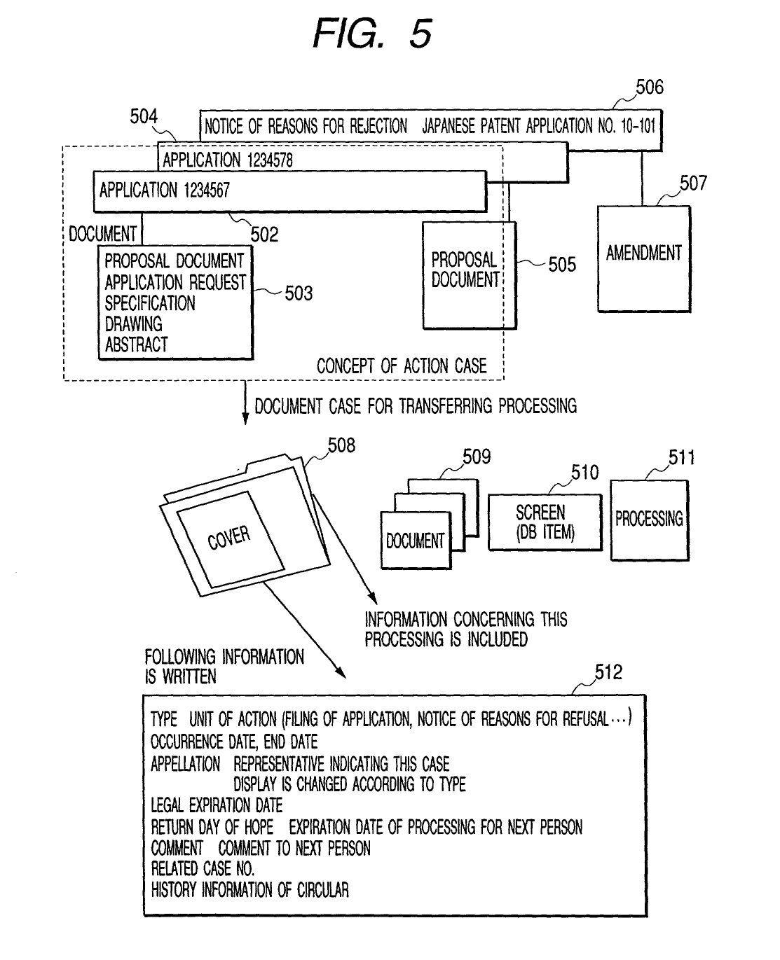

FIG. 5 shows the concept of the above mentioned action case.

In FIG. 5, reference numeral 501 denotes an action case, and contents 502 and 503 of the action case respectively correspond to the application action 404 and the document 407. Reference numerals 504, 505, 506, and 507 respectively correspond to 405, 409, 406, and 411.

As described above, the action case is a virtual file in the system indicated by 508, and contains a cover 512 describing the type indicating the unit of an action such as an application, rejection reason, as a description item, an occurrence date and an end date of the action, the appellation of an action case (the representative appellation of the case when a series of actions have a plurality of documents), a legal expiration date, a requested return date of an action case (an expiration date of processing for the next person), the comment to the next person, a related case number, the history information about the circulation of an action case (through whom the case has reached the user), etc. Necessary document 509 for the process, and a DB item 510 to be input on the screen (displayed) are inserted. Furthermore, when an amendment has been generated, a process result 511 is inserted by a person who has performed the process. The process result 511 can be completely inserted by a person who has received an action case uploading the process contents to the system, and registering them in the electronic file wrapper 412.

The concept of an action case can be varied. For example, it can be delimited in shorter units. For example, it can be delimited in generating a proposal document, checking a draft, etc. Furthermore, a plurality of submission documents to Patent Office can be collectively moved and processed as one action case.

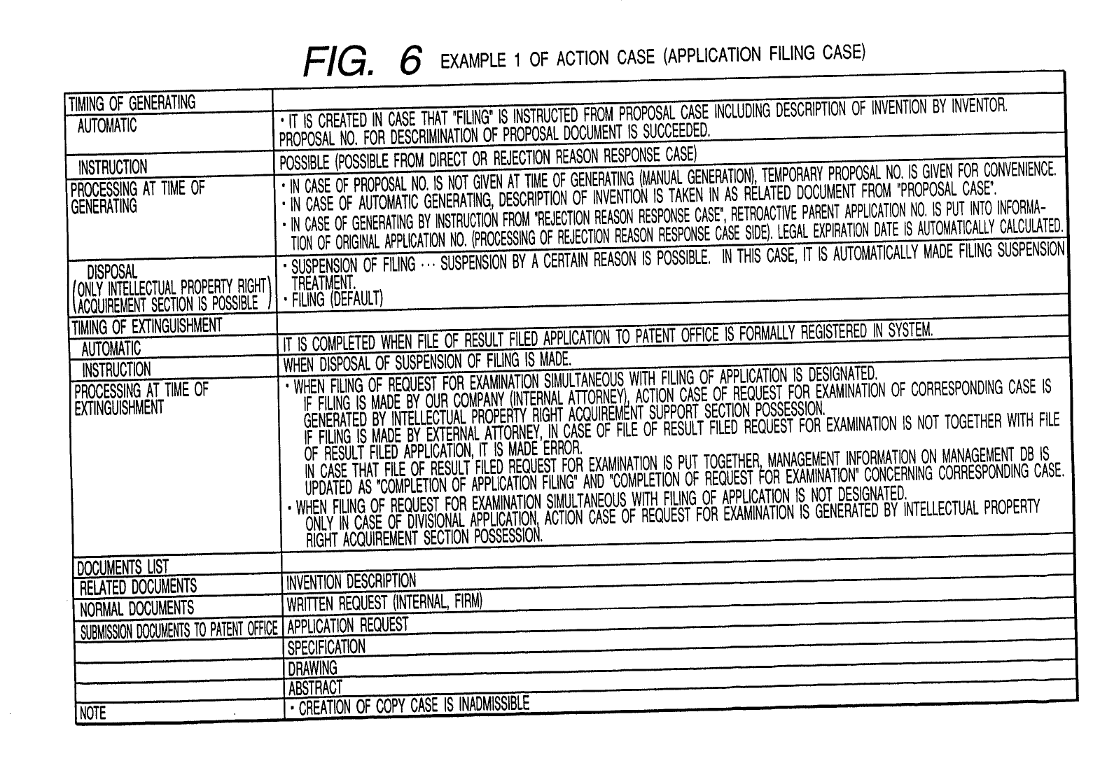

FIGS. 6 through 8 show examples of action cases.

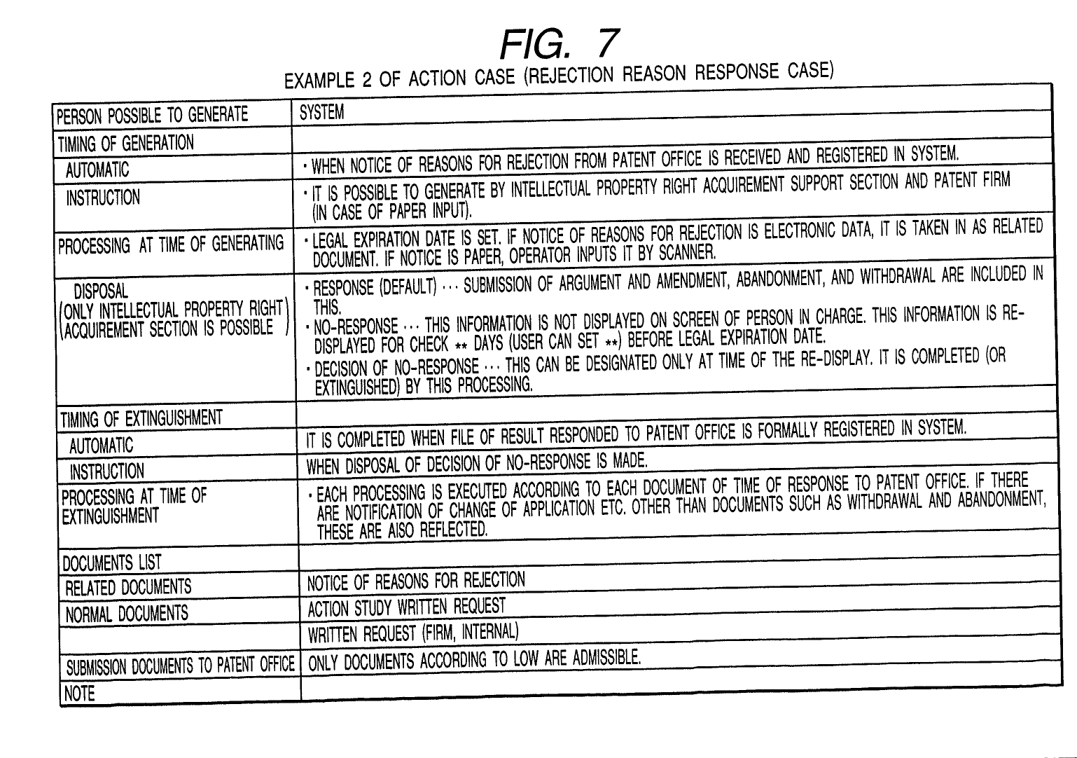

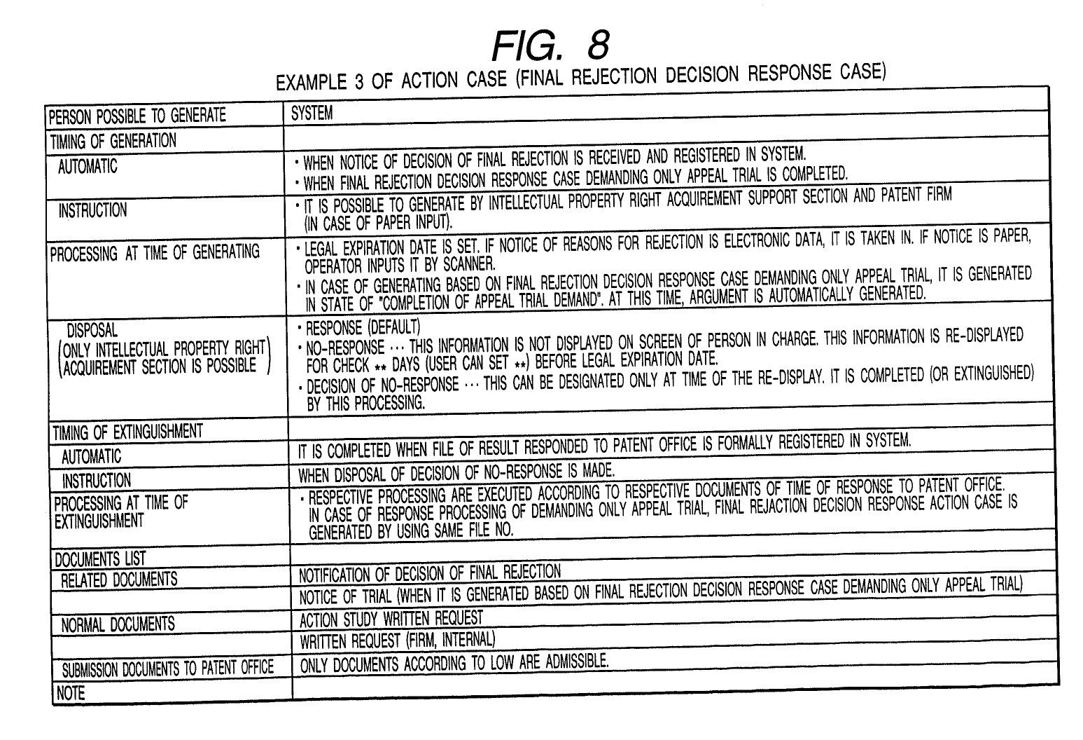

FIG. 6 shows an application case of generating (preparing) an application document. FIG. 7 shows a rejection reason response case in response to a rejection reason. FIG. 8 shows a final rejection decision response case in response to a final rejection. The final rejection decision response case corresponds to JP and EP, but corresponds to an appeal in the US.

In each action, the timing of the occurrence of an action case, the process performed at the occurrence, the timing of extinguishment, the process for the extinguishment, the documents related to the process, etc. are defined. Other actions such as a request for examination, etc. can also be defined in the same manner.

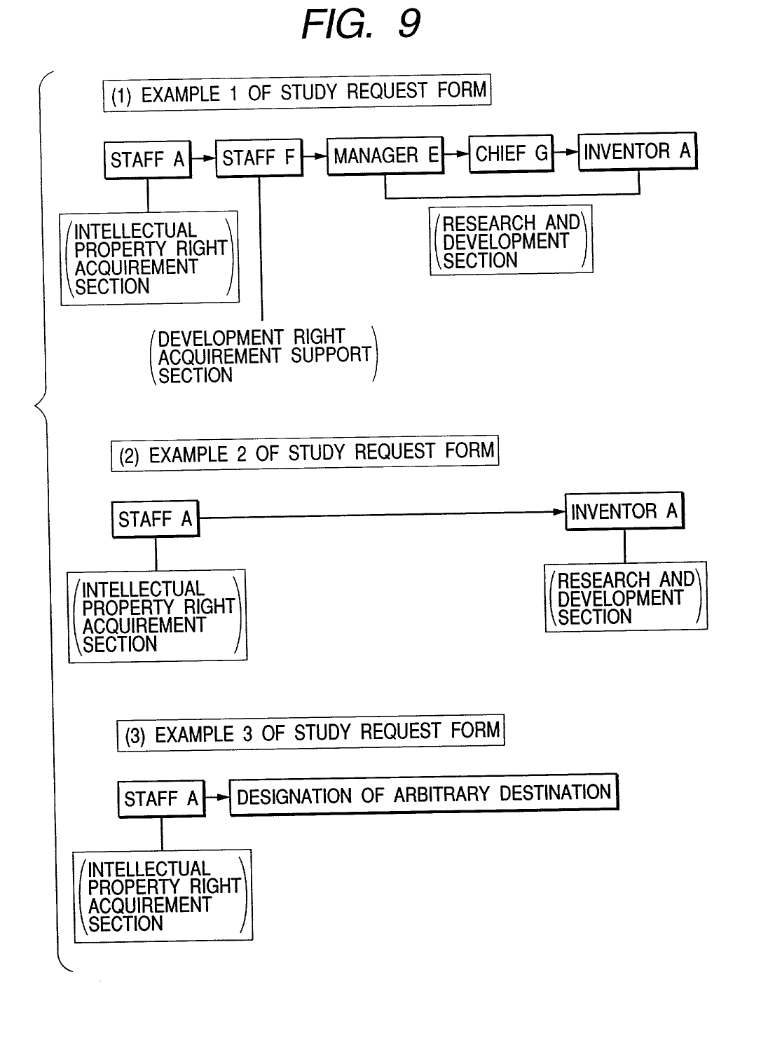

FIG. 9 shows an example of a study path of an action with the organization configuration as shown in FIG. 3.

For example, (1) refers to an example 1 of the study request form, and shows the path through which an action case is transferred from the staff A to the inventor A through the staff F, the manager E, and the chief G. For example, the study of a rejection reason corresponds to this pattern. (2) refers to an example 2 of the study request form, and shows the transfer of an action case from the staff A directly to the inventor A. For example, a check of an application original corresponds to this pattern. (3) refers to an example 3 of a study request form, and shows the case in which the staff A sequentially specifies an arbitrary destination for transfer of an action case to a studying person.

In (1) and (2) above, the system manages the work flow to automatically transferring the case. On the other hand, in (3) above, a person receiving the case transfers the case to a target person at his or her own discretion according to the in-house rule. From the viewpoint of the automation of a process, the former excels, but has the demerit that it cannot flexibly perform a process in an organization. According to the present embodiment, the system supports both, thereby flexibly operating the system depending on the type and situation the type of action and section.

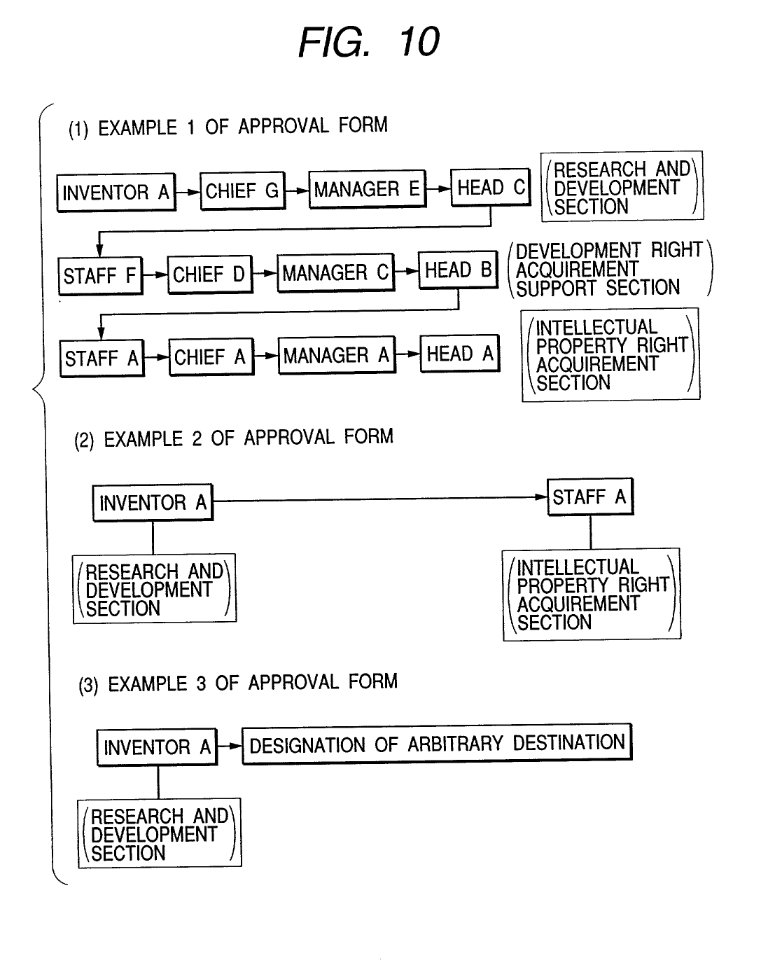

Similarly, FIG. 10 shows an example of the path of the approval of an action study result.

For example, (1) is the example 1 of an approval form, and shows the path of the transfer of an action case from the inventor A to the head A through the chief G, the manager E, the head C, the staff F, the chief D, the manager C, the head B, the staff A, the chief A, and the manager A. For example, approving and accepting an invention proposal document correspond to this pattern. (2) is the example 2 of an approval form, and shows the path of the transfer of an action case from the inventor A directly to the staff A. For example, checking an application original, answering in an urgency, etc. correspond to this pattern. (3) is the example 3 of a study request form, and shows the case in which an action case is transferred from the inventor A to the final person for approval with arbitrary destinations sequentially specified.

In the case of approval, the form of (3) is provided for the same reason as in the above mentioned study request.

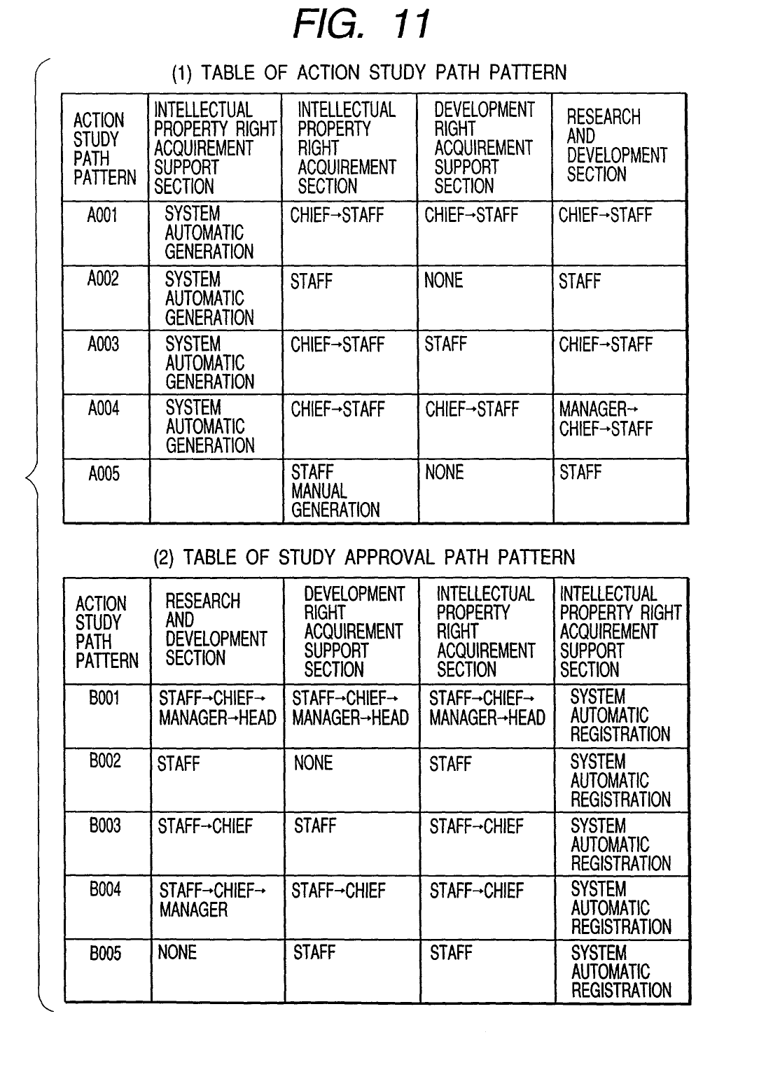

FIG. 11 shows a table of a path pattern of the study and the approval of an action shown in FIGS. 9 and 10. (1) shows a study path pattern, and describes the patterns from A001 to A005 as examples. For example, A001 is a pattern in which an action case is automatically generated by the system, and is transferred from a chief of the intellectual property right acquirement section to a staff, from a chief of the development right acquirement support section to a staff, and from a chief of the research and development section to a staff. (2) shows a study result approval path pattern, and describes the patterns from B001 to B005 as examples. For example, in B002, the system automatically registers a study result after an action case is transferred from a staff in the research and development section to a staff in the intellectual property right acquirement section.

These path patterns are registered in the server 119 so that the work flow management can be smoothly controlled. Furthermore, by setting the path pattern as a table, the work flow of an action case can be easily changed only by changing the table. In this table, patterns of destination-designated arbitrary path can be defined as A000 and B000.

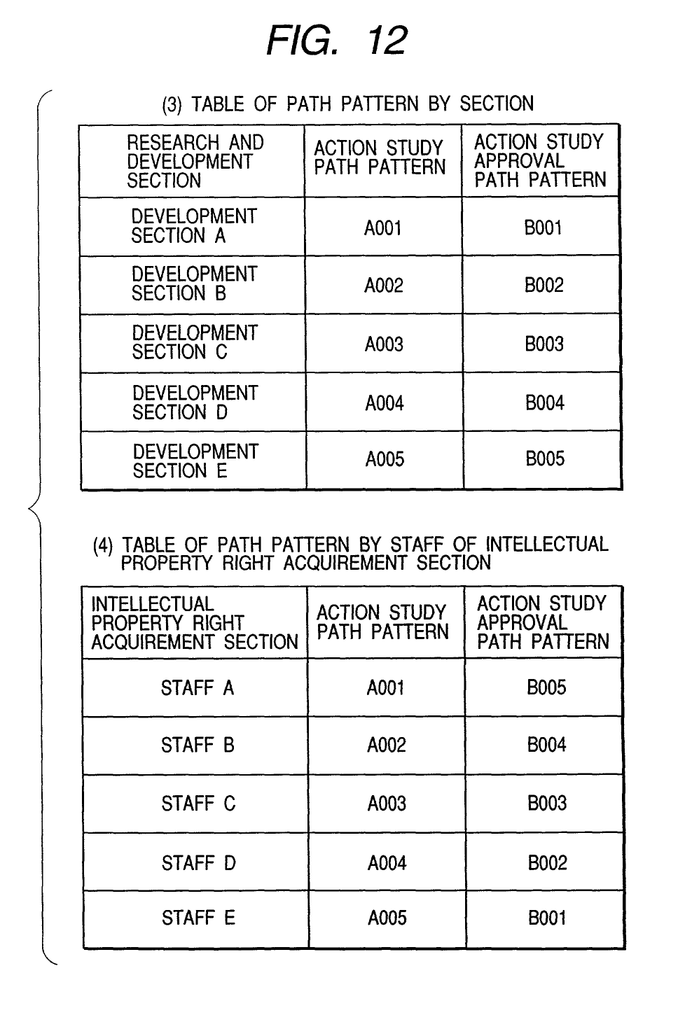

FIG. 12 is a pattern selection table for free assembly of a work flow by section (3), and by staff of the intellectual property right acquirement section (4) by using pattern tables shown in FIG. 11.

For example, the development section A selects A001 as a action study path pattern, and selects B001 as a study approval path pattern. Otherwise, the staff A selects A001 as an action study path pattern, and B005 as a study approval path pattern. Using the pattern selection table, the customization by section or by staff can be realized. In addition, a pattern table or a selection table can be used for each type of action case.

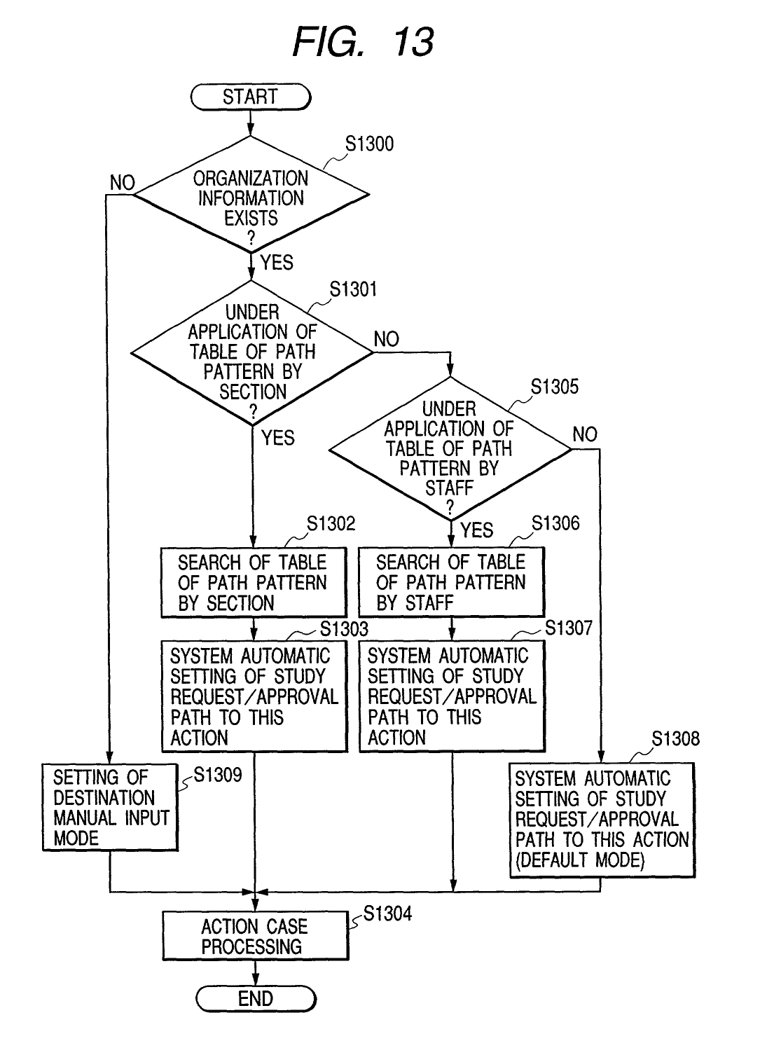

FIG. 13 is a flowchart of setting a flow of an action case.

First, it is determined in S1300 whether or not the organization information shown in FIG. 3 has been registered in the system, and it is determined in S1301 whether or not it is set such that the table of path pattern by section shown in (3) of FIG. 12 can be applied. When it is applied, the table of path pattern by section is searched in S1302, the system automatically sets a study request and approval path for the action case in S1303, and an action case process is performed in S1304.

On the other hand, when the table of path pattern by section is not applied (NO in S1301), it is determined in S1305 whether or not it is set such that the table of path pattern by staff in the intellectual property right acquirement section can be set. If YES, the table of path pattern by staff is searched in S1306, the system automatically sets a study request and an approval path for the action case in S1307, and an actual action case process is performed in S1304.

On the other hand, when the table of path pattern by staff is not applied (NO in S1305), the system automatically sets a predetermined default mode for the study request and approval path for the action case in S1308.

When there is no organization information (NO in S1200), a mode in which a destination is manually input is set in S1309.

As described above, by combining the organization information with a path table and a selection table, the transfer of an action case can be efficiently managed.

### Document Follow-up Function of Action Case

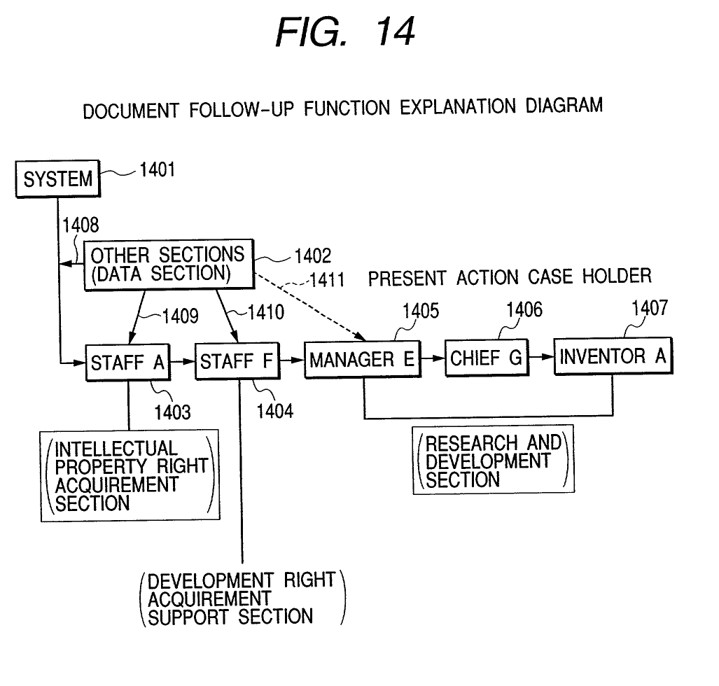

FIG. 14 shows the document follow-up function of a document to be stored in an action case.

In this example, a study request for an action case automatically generated by a system 1401 is transferred in the order of the staff A (1403), the staff F (1404), the manager E (1405), the chief G (1406), and the inventor A (1407). In this case, if an action case is maintained in the system until the cited document is obtained when the system 1401 generates an action case, and when it takes some time for a user to obtain a part of the cited documents described in the notice of reasons for rejection, then time required for actual study is wasted, thereby causing low efficiency.

On the other hand, until an action is transferred to a person who actually studies a response to a notice of reasons for rejection, it is often possible to appropriately determine without a part of cited documents the process of determining a person who studies a response, etc.

Then, according to the present embodiment, in this case, when the circulation is started with a part of documents not yet obtained for an action case, and necessary documents are obtained later, the system 1401 additionally inserts the documents obtained from other sections 1402 such as a material section, etc. to the case of the holder of the action case as follow-up, and the mail for informing that the documents (document follow-up material) have been inserted is transmitted to a person who has already passed the action case.

The follow-up document can be transmitted from a section (person) which is not a section (person) generating the original study request as described above, or can be transmitted from the same section (person).

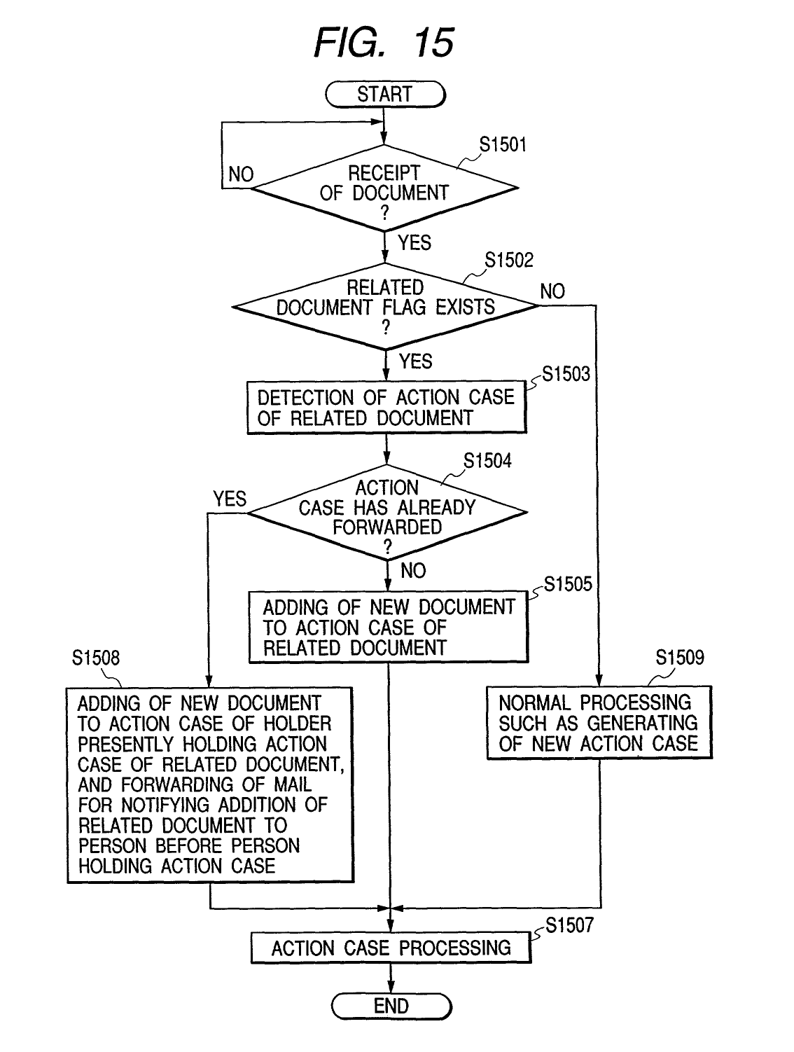

FIG. 15 is a flowchart of the document follow-up process.

First, when the system receives a document in S1501, it is determined in S1502 whether or not the document is provided with a flag of a related document (identification code for identifying a related document). If a related document flag is provided, the action case of the related documents is detected in S1503. Then, in S1504, it is determined whether or not the action case has been transmitted and is beyond the control of the system. If NOT, a newly received document is added to the action case of the related documents in S1505, and is transmitted, and control is passed to the process of the action case in S1507.

On the other hand, if the action case has been transmitted (YES in S1504), a new document is added to the action case of a person who currently holds the action case of the related documents, and notification mail about the added document is transmitted to a person preceding the person holding the above mentioned action case, that is, a person already described in the circulation history. The person who has received the mail can be inspected in the system of the newly added document. The document to be added can be attached to the mail, or the mail can be accessed by describing the address in the DB of the added document. In this case, a person who has already passed an action case cannot register a document such as an amendment, etc. to the action case. However, if it is necessary to perform an important process on the action case, a necessary document can be registered when the action case is returned or a check result is returned.

If there is no flags of related documents (NO in S1502), a normal process such as generating a new action case, etc. is performed in S1509.

By the above mentioned document follow-up function, the studying process can be efficiently performed by effectively using the limited studying time. The above mentioned document follow-up function is not limited to the above mentioned study of the action (a notice of reasons for rejection, etc.) of a patent, but can be applied to any study performed by a plurality of staffs who study anything through a network, thereby performing efficiently study through a network.

### Function of Copying Action Case

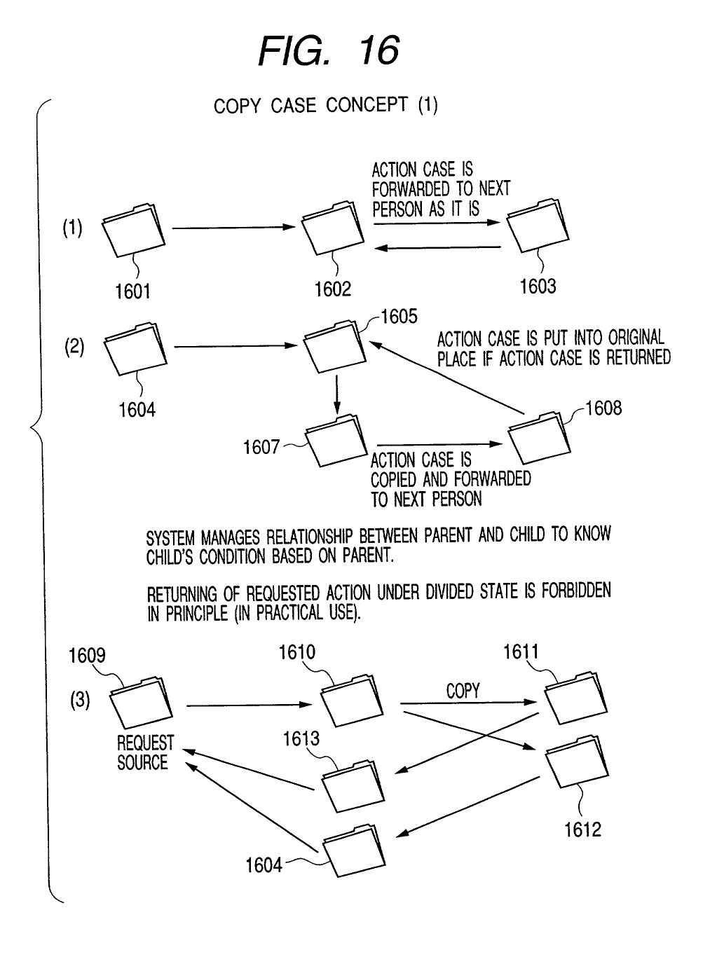

FIG. 16 shows the function of copying an action case.

In a method of using the above mentioned action case, typically a person who has received the action case 1601 assigns the number 1602 to the case and pass it to the next person as 1603 as it is as shown in (1) of FIG. 16.

On the other hand, as shown in (2) of FIG. 16, a person who has received an action case 1604 processes it as 1605 by himself or herself, and may also request the next person to study it simultaneously. In this case, in the system according to the present embodiment, the person generates a copy case 1607 of the action case 1605, holds the action case 1605, and can have another person study the copy case 1607. However, in principle in this case, the person who has generated the copy case can integrate a case 1608 which has been copied and returned. That is, dividing a requested action case and returning it to the originating person is prohibited in principle.

A use form of a copy case is not limited to the above mentioned example. That is, as shown in 3, the holder of 1610 copies a case 1609 received from a requester, divides it into 1611 and 1612, and can pass them for parallel study. However, returned 1613 and 1614 are not returned as separate cases to the requester, but the person who made copies integrates and returns them to the requester.

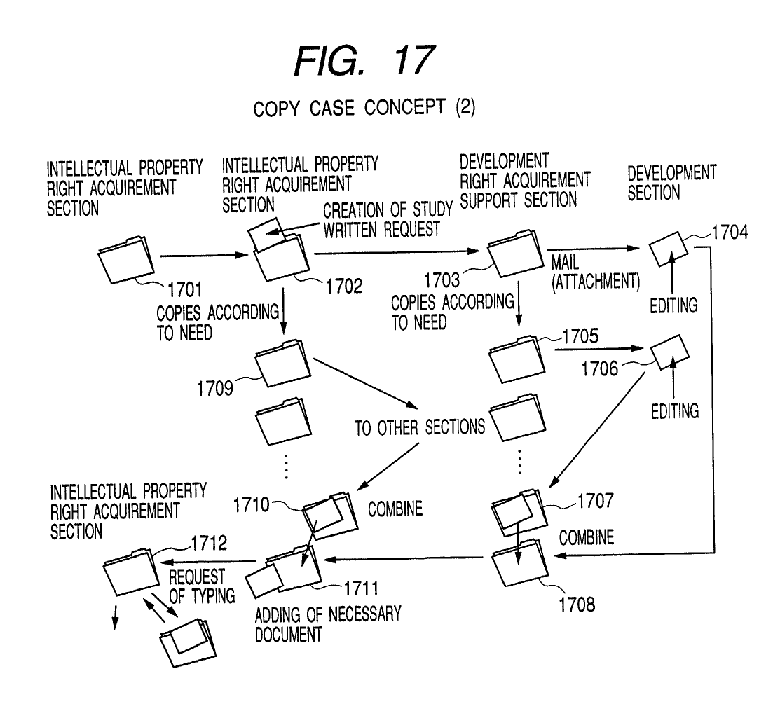

FIG. 17 practically shows the method of using a copy case.

An action case 1701 from the intellectual property right acquirement support section 106 is transmitted with a written study request generated in the intellectual property right acquirement section 105 to the development right acquirement support section 103 as 1702, and a copy case 1709 is generated and transmitted to other sections.

The development right acquirement support section 103 transmits a written study request of a case 1703 as an attached document of electronic mail to the research and development section 102, on the other hand, generates a copy case, and transmits a written study request of a copy case 1705 as an attached document of electronic mail to another development section.

The research and development section 102 edits study results 1704 and 1706, and returns them as 1707 and 1708 respectively to the development right acquirement support section 103. Then, they are combined and integrated, and returned to the requester, that is, the intellectual property right acquirement section 105. In this example, a study result 1710 corresponding to the study request which has been passed to another section for study is combined and integrated with 1711, a necessary document is generated and added, and 1712 is passed to the intellectual property right acquirement support section 106 for a typing request process, etc.

By using the above mentioned function of copying an action case, a plurality of staffs can efficiently study a requested item within a short time.

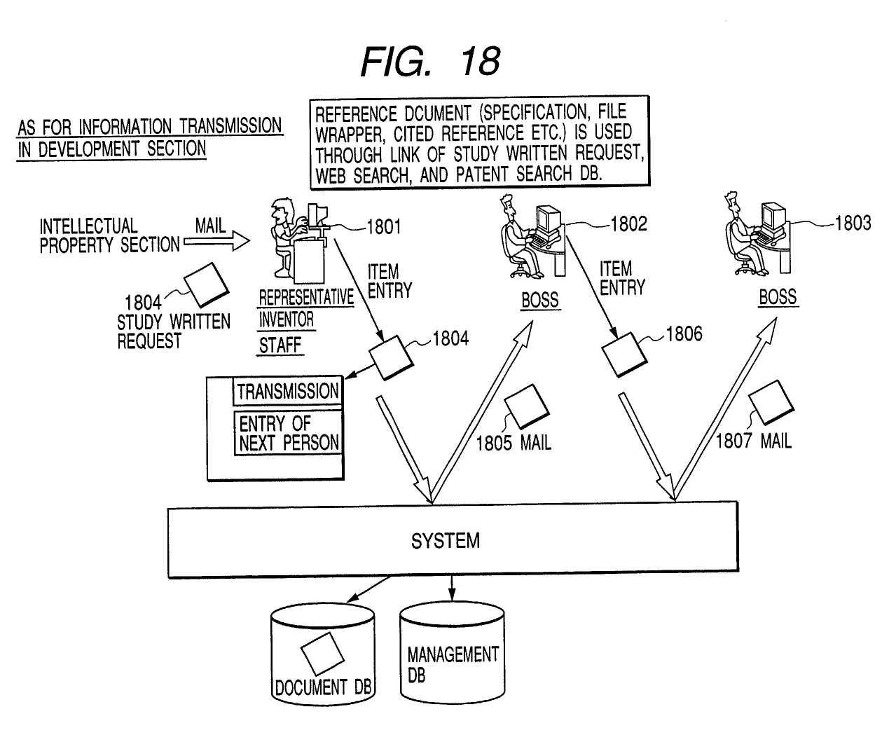

FIG. 18 shows an example (a case in which a studying person sequentially specifies the next studying person) of a method of transmitting information in the research and development section 102.

When a written study request 1804 is transmitted by mail from the intellectual property right acquirement section (105, 106, or 103), a representative inventor and a staff 1801 enter a necessary study item and the next studying person in the document 1804 on their PCs, and input a transmission instruction using a transmission button embedded as a macro on the document. Using the transmission button, the document 1804 is registered in the system, stored in the document server 116, and mail 1805 is transmitted to the next studying person (approver). Then, a next boss 1802 enters an item on a document 1806 similarly, registers it in the system, and transmits mail 1807 to a boss 1803.

The above mentioned work flow is managed by the system, and the studying person input the next studying person (approver), pushes the transmission button, thereby performing the system registration and mail transmission.

### Invoice Process

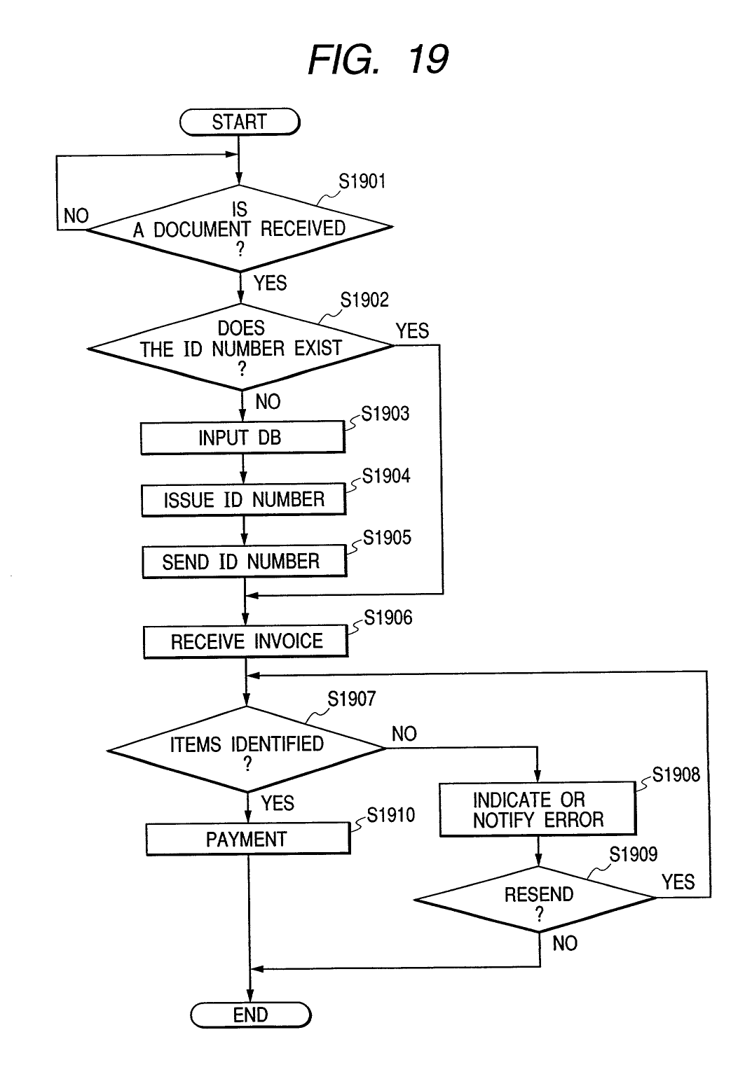

FIG. 19 is a flowchart of the invoice process from an intellectual property related firm in the present system.

In FIG. 19, when a document (for example, a notice of reasons for rejection, drafts of an argument and an amendment, an application original, a foreign application original, etc.) from an organization other than Patent Office (for example, an attorney's office, a translator's office, etc. which are hereinafter referred to as an intellectual property related firm) in S1901, it is confirmed in S1902 whether or not an ID number at the time of request for a service (for example, an ID number assigned when a request is issued to an attorney's office, etc.) has been added. If an ID number has been assigned, control is passed to S1906. If it has not been assigned, then a document is input to the DB in S1903, an ID number is issued in S1904, and the ID number is transmitted to the intellectual property related office in S1905.

In S1906, an invoice is received, and the ID number and the item (type, etc.) of the document are confirmed. For example, if the contents of the invoice refer to an item of a rejection reason notice response for the ID number about the item of a request for preparing an application original, it is an error. Furthermore, if an invoice of an amount equal to or larger than a predetermined value set in the system in advance has been issued, then it is displayed on the in-house client PC, and an error notification is manually issued unless non-error can be confirmed offline (for example, by phone, facsimile, etc.).

If an item and an ID number matches in S1907, then a payment is made in S1910. If they do not match, an error notification is displayed in S1908, and it is reported to an intellectual property related office. Then, it is confirmed in S1909 whether or not the invoice is to be re-transmitted.

As described above, an ID is assigned to a requested service, and is compared with the contents when the service is provided, thereby easily linking the contents of the service to the invoice in the system.

### Second Embodiment

### Entire Configuration of Intellectual Property Management System

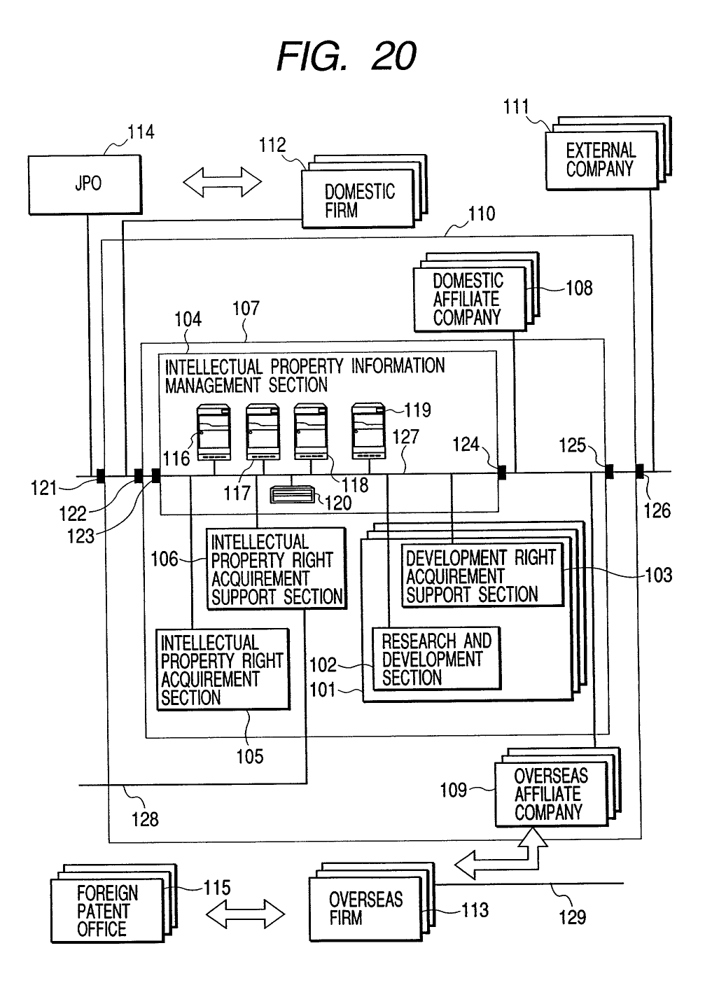

FIG. 20 shows the typical configuration of the intellectual property management system according to the second embodiment of the present invention.

The basic configuration and function are the same as in FIG. 1. The system shown in FIG. 1 is basically operated online through networks regardless of domestic or foreign use, but the present embodiment is different from the first embodiment in the following points.

Reference numerals 128 and 129 denote public lines through which facsimile data can be communicated. Each of the intellectual property right acquirement support section 106, the overseas firm 113, the domestic firm 112, etc. comprises at least one facsimile device.

The ideal form of the entire system is the totally online system as in the first embodiment as described above. However, there can arise an environment in which electronic mail and Web temporarily cannot be used.

Therefore, according to the present embodiment, a paper medium and facsimile communications are used as ancillary communications means.

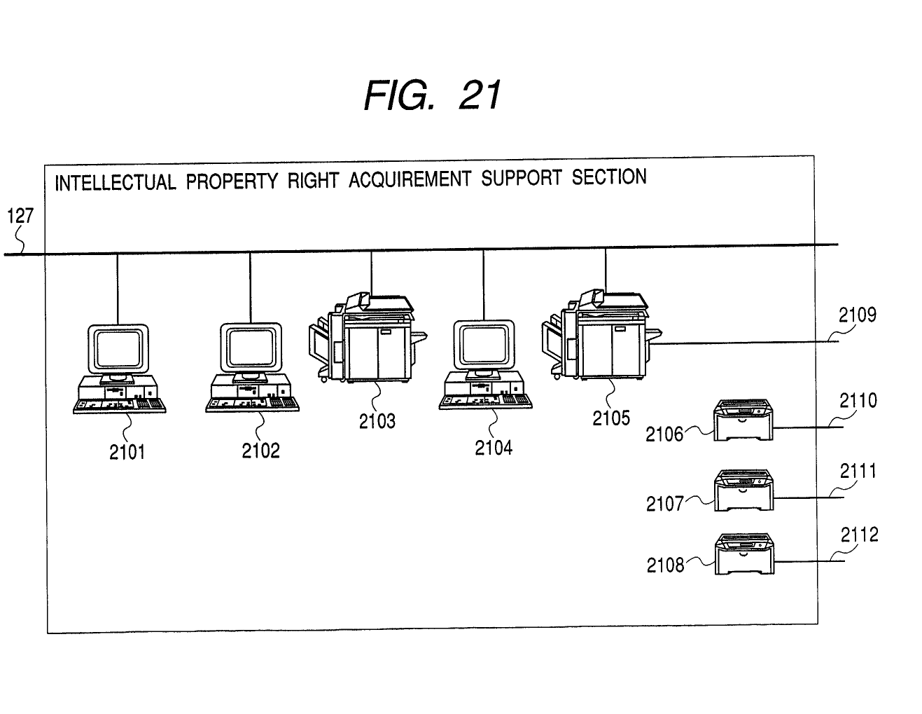

FIG. 21 shows an example of an OA appliance provided in the intellectual property right acquirement support section 106.

Clients 2101, 2102, and 2104, a high-speed scanner printer 2103, and a high-speed scanner-printer-facsimile compound machine 2105 are connected to the basic network 127. In addition, the PC 2102 has the function of the server of the scanner printer 2103, and the PC 2104 has the function of the server of the compound machine 2105. Reference numeral 2109 denotes an analog or digital public line, and is used by the compound machine 2105 for transmission and reception of facsimile data. Reference numerals 2106, 2107, and 2108 denote stand-alone facsimile devices, and perform facsimile communications through public lines 2110, 2111, and 2112 respectively.

The intellectual property right acquirement support section 106 communicates information by facsimile with external firms such as the overseas firm 113, the domestic firm 112, etc.

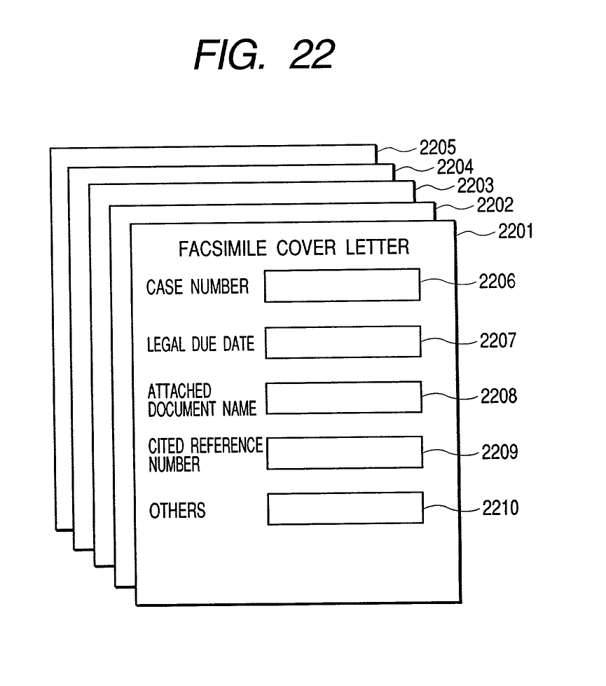

At this time, in an urgency (when the term of an answer comes soon, etc.), a transmitter performs facsimile communications to the urgency exclusive line 2109 in a plurality of lines, and uses a sheet as shown in FIG. 22 as a cover page of the facsimile communications.

In FIG. 22, a cover sheet 2201 describes a case number and its OCR bar code 2206, a legal due date and its OCR bar code 2207, an attached document name and its OCR bar code 2208, a cited reference number and its OCR bar code 2209, and other bibliographic information and its OCR bar code 2210, and is read on the transmission side. Reference numeral 2202 denotes, for example, an office action (notice of reasons for rejection), reference numeral 2203 denotes the first cited document, reference numeral 2204 denotes the second cited document, and reference numeral 2205 denotes the third cited document.

Thus, by receiving the bibliographic information with the OCR code on the front page, a server 2104 recognizes process information from the facsimile data fetched through a compound machine 2105, and electronic data about bibliographic information can be provided for the system. In addition, the office action 2202, and the cited document 2203 to 2205 can also be fetched as facsimile data (electronic data) to the system.

The bibliographic information extracted from the front page 2201 is registered in the management server 117, and the above mentioned action cases are automatically generated by the server 119 depending on the legal due date and the specified due date of an answer to an office. On the other hand, the facsimile data of 2202 to 2205 is registered in the document server 116. The facsimile data can be transmitted in the G3 system or the G4 system, and also can be compressed data such as JBIG, etc. Especially, in the system in which facsimile data can be directly fetched to a database as in the system according to the present embodiment, the data in the hierarchical coding system as the JBIG is effective when a user uses the data after inputting it in a database.

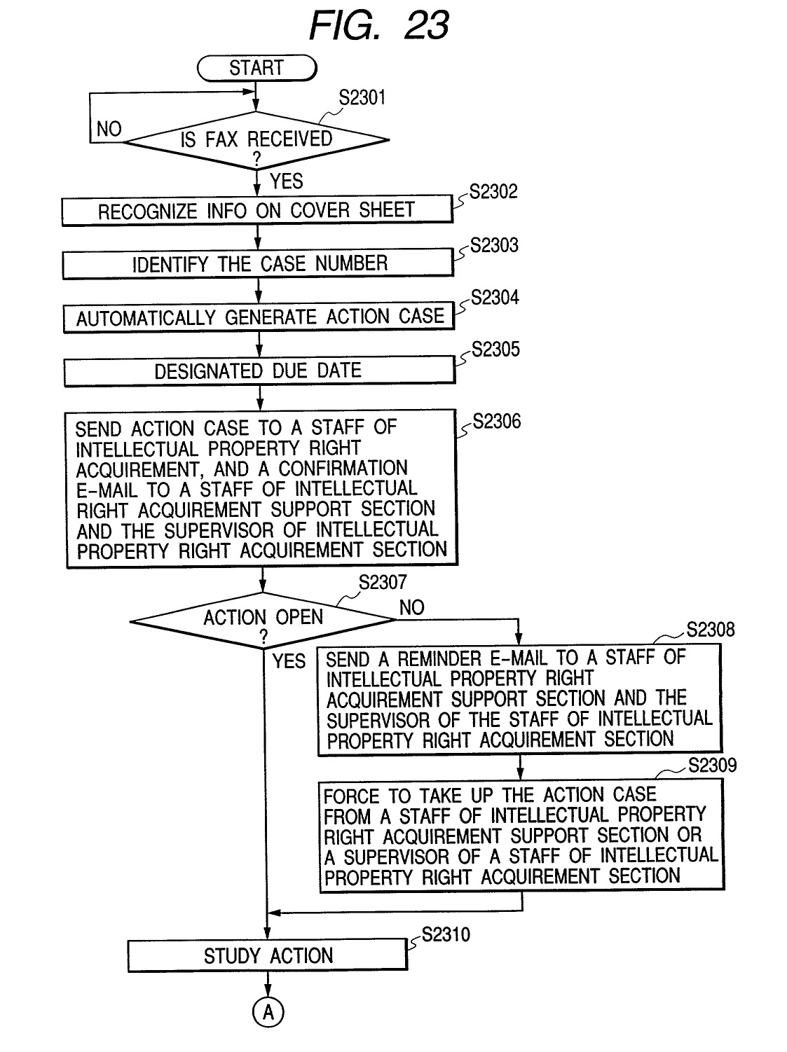

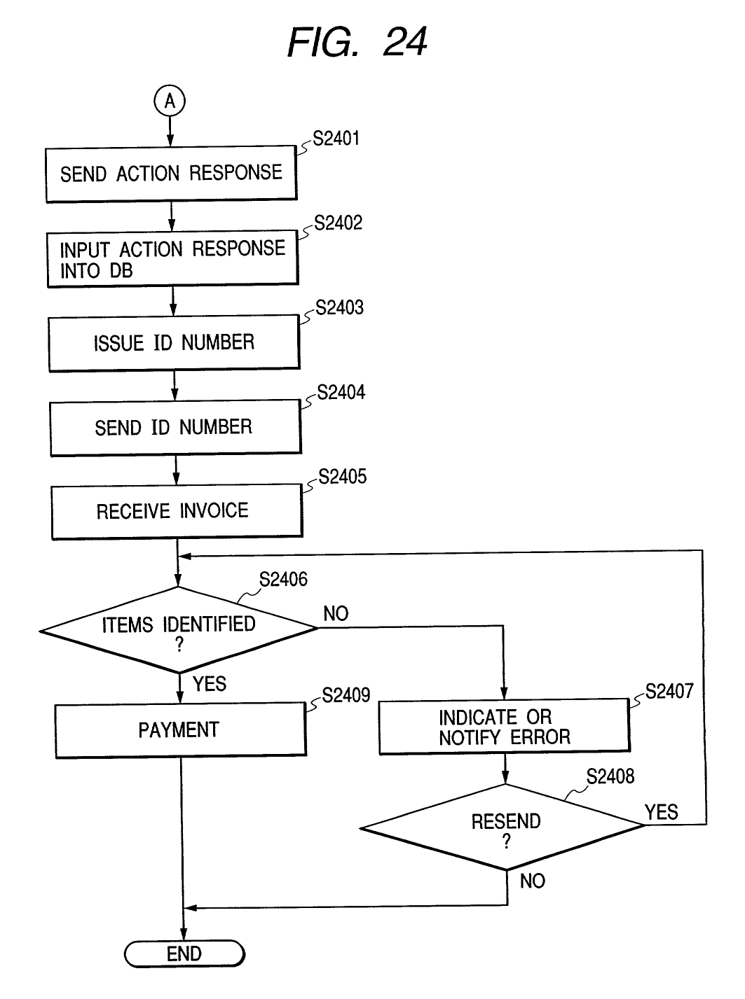

FIGS. 23 and 24 are flowcharts indicating the flow of the above mentioned process.

In these figures, facsimile data is awaited from an office, etc. in S2301. When it is received, the FAX server 2104 recognizes in S2302 the information in the above mentioned cover letter 2201 by the OCR function.

According to the present embodiment, the facsimile data contains item information (case number) for specification of a case managed by the management server 117, due date information for the current action, document name information about an attached document, attached cited document information, etc. issued by Patent Office, etc. Then, in S2302, the management information is registered in the management server 117, the document data 2202 to 2205 is registered in the document server 116, the server 119 specifies a case number, and automatically generates an action case.

A due date is set in S2305 (when a legal due date is applied, it is set, and when an office-specified due date is adopted, both dates are set). In S2306, the server 119 transmits an action case to a staff of the intellectual property right acquirement section, and transmits mail informing that an urgent action case has been received to the staff of the intellectual property right acquirement section and the boss of the staff of the intellectual property right acquirement section.

Then, in S2307, the system checks whether or not the action case has been accessed by the staff of the intellectual property right acquirement section after a predetermined time (for example, three hours) has passed. If yes, the staff studies the action in S2310.

On the other hand, if the action case has not been opened (NO in S2307), in S2308, reminder mail is transmitted to the staff in the intellectual property right acquirement support section and the boss of the staff of the intellectual property right acquirement section, and the staff in the intellectual property right acquirement support section or the boss of the staff of the intellectual property right acquirement section forcibly claims back the action case in S2309, and re-transmits the action case to another staff or process it by himself or herself.

After studying an action, in S2401, an answer to the action is transmitted through the system or by facsimile to an office through the system, and the bibliographic information in response to the action is registered in the DB of the management server 117 in S2402. Then, the server 119 issues an ID number to the action response (response request) in S2403, and the ID number is transmitted to the destination (office, etc.) of the action response in S2404. Then, in S2405, an invoice from the destination of the action response. If the item and others of the invoice match in S2406, then the invoice amount is paid in S2409. If they do not match, then an error notification is displayed and transmitted to a destination in S2407, and the above mentioned check is repeated if re-transmission is performed in S2408.

The above mentioned ID number can be issued when urgent facsimile information is received, or an action case is issued.

Furthermore, the payment of an invoiced amount can be made online or offline.

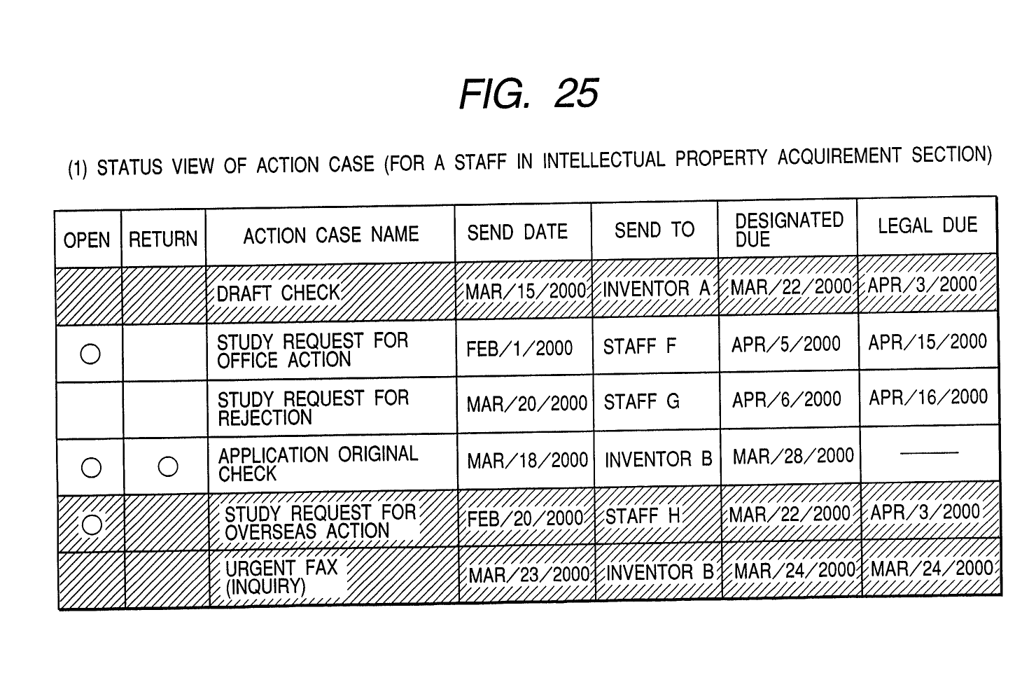

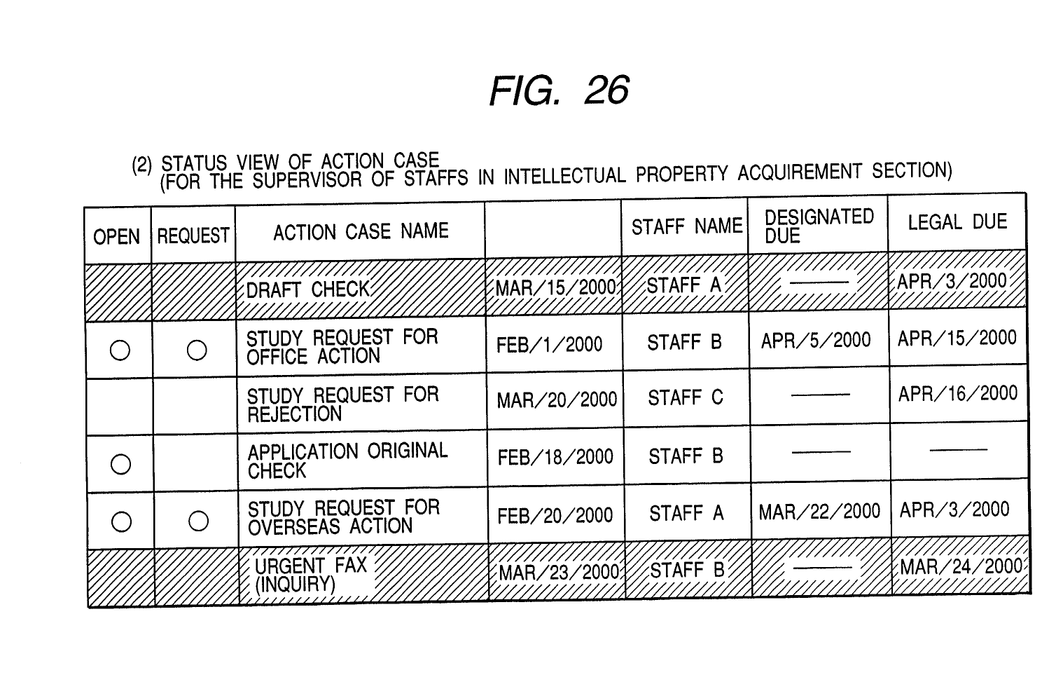

FIGS. 25 and 26 show the configuration of the display screen for a user confirming the process situation of an action case.

FIG. 25 shows an example of the display screen when the staff in the intellectual property right acquirement section confirms the process situation of an action case on the client PC.

As display items, ‘open’ indicating whether or not a person receiving an action case has accessed the action case, ‘return’ indicating whether or not the return of the action case has been received, ‘action case name’ indicating the type of action case, ‘transmission date’ indicating the date of the transmission of the action case, ‘destination’ indicating the destination of the action case, ‘specified due date’ indicating the due date of the study of the action set by the transmitter of the action case, and ‘legal due date’ indicating the due date of the document to Patent Office, etc. are sequentially displayed.

An example of a rule of the display method is described below.

1. The system detects that the action case has been accessed at the destination, and the ‘open’ box is marked.

2. If the action case is not ‘opened’ N days (for example, 3 days) after the transmission date, a visual reminder is transmitted to the staff of the intellectual property right acquirement section on the necessary display (for example, using a yellow paint) for the action case.

3. When the specified due date has been passed, the action case is painted in color (for example, blue) different from the color of 2 above regardless of whether or not the action case has been ‘opened’ as a visual reminder to the staff of the intellectual property right acquirement section (however, an already returned action case is not painted).

4. M days (for example, seven days) prior to the legal due date, the action case is painted in color (for example, red) different from the colors of 2 and 3 above regardless of whether or not the action case has been ‘opened’, or whether or not the specified due date has been passed, thereby visually reminding the staff in the intellectual property right acquirement section of the action case.

5. About the action case occurring by urgent facsimile, the action case is painted in the same color as 4 above regardless of whether or not the action case has been ‘opened’ to visually remind the staff in the intellectual property right acquirement section of the action case.

6. The conditions of the above mentioned display parameter (reminding conditions such as values of N and M, color of the paint, etc.) are set by the staff in the intellectual property right acquirement section on the client PC, and stored in the non-volatile memory of the client PC, thereby successfully customizing the process.

FIG. 26 shows an example of a display screen used when the boss in the intellectual property right acquirement section or the staff in the intellectual property right acquirement support section confirms the process situation of the action case of the staff of the intellectual property right acquirement section on the client PC.

As display items, ‘open’ indicating whether or not the staff in the intellectual property right acquirement section in charge of the action case has accessed the action case, ‘request’ indicating whether or not the action case has been transmitted in a study request, ‘action case name’ indicating the type of action case, ‘reception date’ indicating the day on which the action case was received by the staff of the intellectual property right acquirement section, ‘staff name’ indicating the name of the staff in the intellectual property right acquirement section, ‘specified due date’ indicating the due date of the study of the action set by the transmitter of the action case, and ‘legal due date’ indicating the due date of the document to Patent Office, etc. are sequentially displayed.

An example of a rule of the display method is described below.

1. The system detects that the action case has been accessed by the staff in the intellectual property right acquirement section through the network, and marks the ‘open’ box.

2. The system detects that the staff in the intellectual property right acquirement section has transmitted the action case in a study request through the network, and marks the ‘request’ box.

3. If the action case is not ‘opened’ P days (for example, 7 days) after the reception date on the staff side, a visual reminder is transmitted to the boss of the intellectual property right acquirement section on the necessary display (for example, using a red paint) for the action case.

4. If the action case is not ‘requested’ Q days (for example, 10 days) after the reception date on the staff side, a visual reminder is transmitted to the boss of the intellectual property right acquirement section on the necessary display (for example, using a yellow paint) for the action case.

5. About the action case occurring by urgent facsimile, the action case is painted in the same color as 3 above regardless of whether or not the action case has been ‘opened’ to visually remind boss of the staff in the intellectual property right acquirement section of the action case.

6. The conditions of the above mentioned display parameter (reminding conditions such as values of P and Q, color of the paint, etc.) are set by the boss of the staff in the intellectual property right acquirement section on the client PC, and stored in the non-volatile memory of the client PC, thereby successfully customizing the process.

Whether or not the action case has been accessed can be recognized by the server 119 periodically checking, for example, whether or not the written study request held as an attached document of the action case by the document server 116 has been accessed.

By providing the above mentioned access check tool, the third party can issue a reminder or perform a process when a error arises in mail or the staff misses mail in a network environment, etc.

### Forcibly Claiming Back Action Case

As described above, a person having predetermined authorization (for example, a boss of a holder of an action case, a person in charge of the management section, a person transmitting an action case to the holder) can forcibly claim back the action case.

It can be realized by, for example, rewriting the information of the work flow management table of the server 119, and changing the holder of the action case. The function is specifically effective when the process of action cases tends to be delayed because the holder of the action case is absent on the business trip, etc.

At this time, mail containing a notification that the forcible claim has been issued, the information about the person who has issued the claim, the information about the claim-back date, etc. is transmitted to the current action case holder. Thus, the action case holder can recognize that the action case held by him or her has been claimed back.

After the claim back, the action holder can perform the studying and approving processes by himself or herself, or can ask another person to study and approve the action case.

The above mentioned tool can also be used in the system according to the first embodiment.

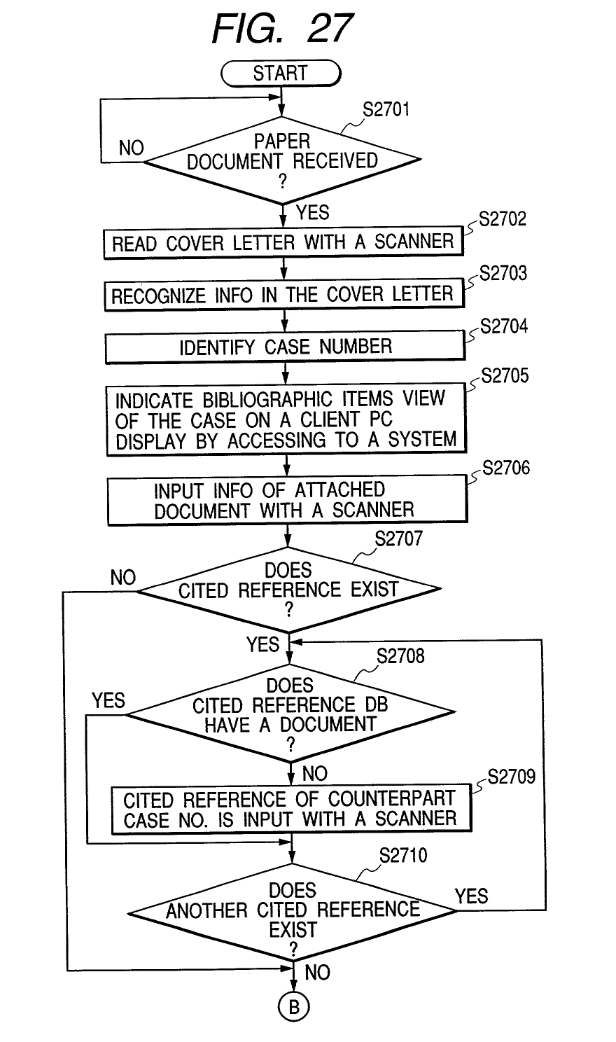

FIG. 27 is a flowchart of the method of inputting to the system a document transmitted by the above mentioned facsimile through a paper medium.

First, in S2701, the intellectual property right acquirement support section receives a paper document. The cover letter of this document can be the same as 2201 shown in FIG. 22.

In S2702, the cover letter 2201 is made to be read by the staff of the intellectual property right acquirement support section using the image scanner of 2103. In S2703, the scanner server 2102 recognizes the information in the cover letter. In S2704, a case number is specified. In S2705, the management server 117 of the system is accessed, and the bibliographic information screen of the corresponding case is displayed on the display unit of 2102, which is a client PC.

Next, the attached document (for example, a notice of reasons for rejection) 2202 is input in S2706. It is determined in S2707 whether or not a cited document has been attached. If yes, it is determined whether or not the cited document has been stored in the server 118 forming part of the DB of the cited document. If it has been already stored, the cited document is not input by the scanner. On the other hand, if the cited document is not contained in the cited document DB, then the staff in the intellectual property right acquirement support section is prompted on the screen of the PC to input a cited document having the corresponding number with a scanner in S2709. If there is another cited document, the processes in S2708 to S2709 are repeated. Afterwards, the processes in S2801 to S 2806 are similar to the processes in S2305 to S2310 shown in FIG. 23. Therefore, the detailed explanation is omitted here. Then, the process in FIG. 24 is performed.

### Document Database

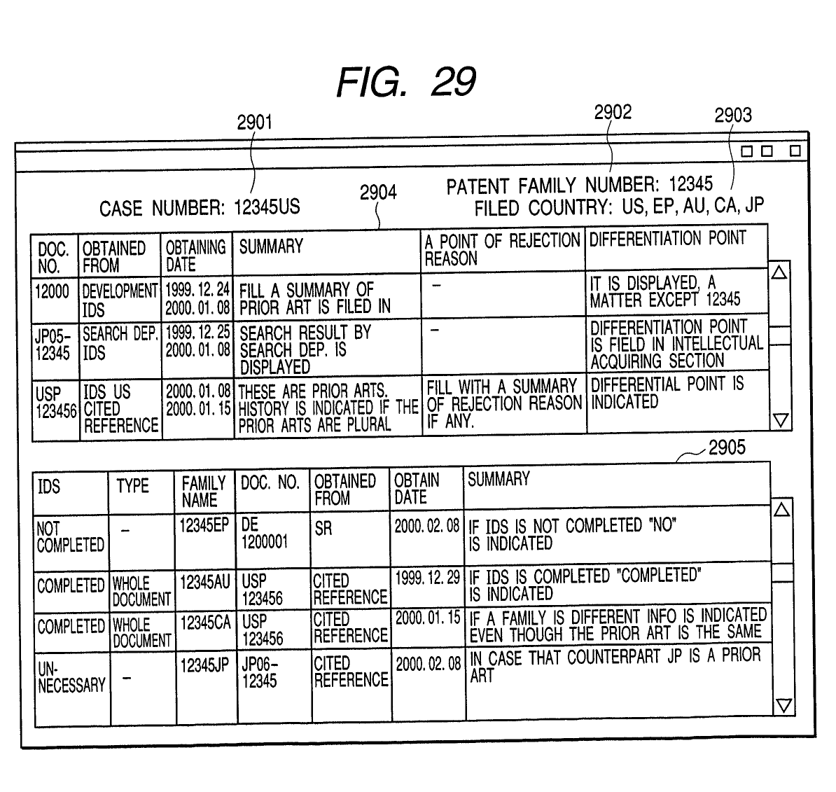

FIGS. 29 to 33 show the display screen of the client PC for explanation of the method of using the cited document database provided in the server 118.

FIG. 29 shows a list of related documents for each case number (case). Reference numeral 2901 denotes a case number, that is, the reference number of the application of the company in each country. In this example, a five-digit number is followed by alphabetical character identifying a country. Reference numeral 2902 denotes a family number indicating an application group practically equivalent in contents of application. Reference numeral 2903 denotes a filed country. In this case, there are the applications of US (the United States), EP (Europe), AU (Australia), and JP (Japan). Reference numeral 2904 denotes a document list relating to the US Patent application of the case number 12345US, and has been cited mainly in the examination by US Patent Office.

In this example, three cases having the document numbers ‘12000 (in-house family number)’, ‘Japanese Patent Application Laid-Open No. 05-12345’, and ‘USP123456’ are listed.

In each document number, items such as a source, an obtaining date, a summary, a point of rejection, a differentiation point in the present application, etc. are displayed, Reference numeral 2905 displays all related documents of the family (in this case, US, EP, AU, and JP) of the case. In this example, four cases except the US case, that is, ‘DE1200001’ in the EP case, ‘USP123456’ in the AU case, ‘USP123456’ in the CA case, and ‘Japanese Patent Application Laid-Open No. 06-12345’ in the JP case, are cited. The source (for example, a search report (SR), the obtaining date, the summary, etc. of each case are displayed. Furthermore, the IDS information indicating whether or not the IDS (information disclosure procedure) has been completed in the U.S. (US) and China (CN) is displayed together. The IDS information can be displayed by one flag with US combined with CN as shown in FIG. 29. US and CN can have respective information, and can be displayed independently.

Thus, the related documents can be displayed for each family, and the status of the IDS of the related documents can be displayed, thereby preventing the omission of the IDS, easily considering documents cited in the examinations in other countries for acquirement of a patent right, and efficiently acquiring effective right.

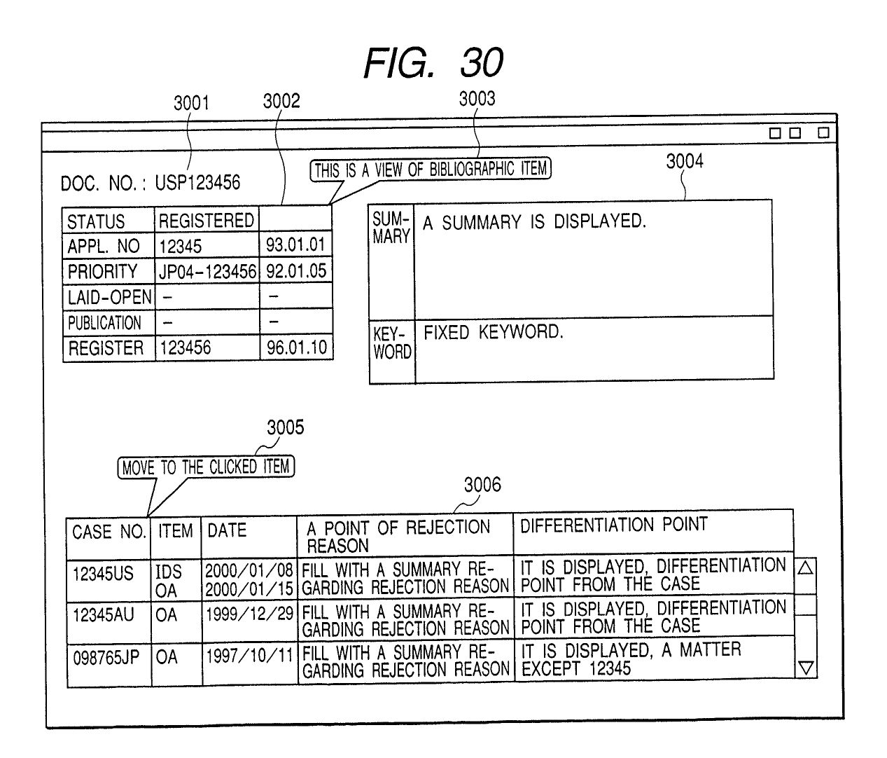

FIG. 30 shows the display screen (type 1) for a reverse tracing by a document. Reference numeral 3001 denotes a document number. Reference numeral 3002 denotes the bibliographic information displaying, for example, the current status, the application number, the filing date, the priority-based application number and the priority day, the laid-open number and the laid-open date, the publication number and the publication date, the registration number and the registration date. Reference numerals 3003 and 3005 are guide displays. By pointing to a portion with the cursor, the function of the portion is displayed. Reference numeral 3004 denotes the summary of the document. Reference numeral 3006 denotes a listing of the in-house cases (case numbers) in which the document has been cited. In this example, when a case number is clicked, the in-house application information registered in the document server 116 can be accessed. In addition, in this example, the item (an office action, etc. in history unit), the date, the portion of the rejection, the differentiation point from the present invention, etc. are displayed for each case number.

Thus, by extracting and displaying an in-house case number by which the document can been cited using the document as a key, the point used when differentiation can be made from the document in other cases can be immediately detected, thereby efficiently studying the office action.

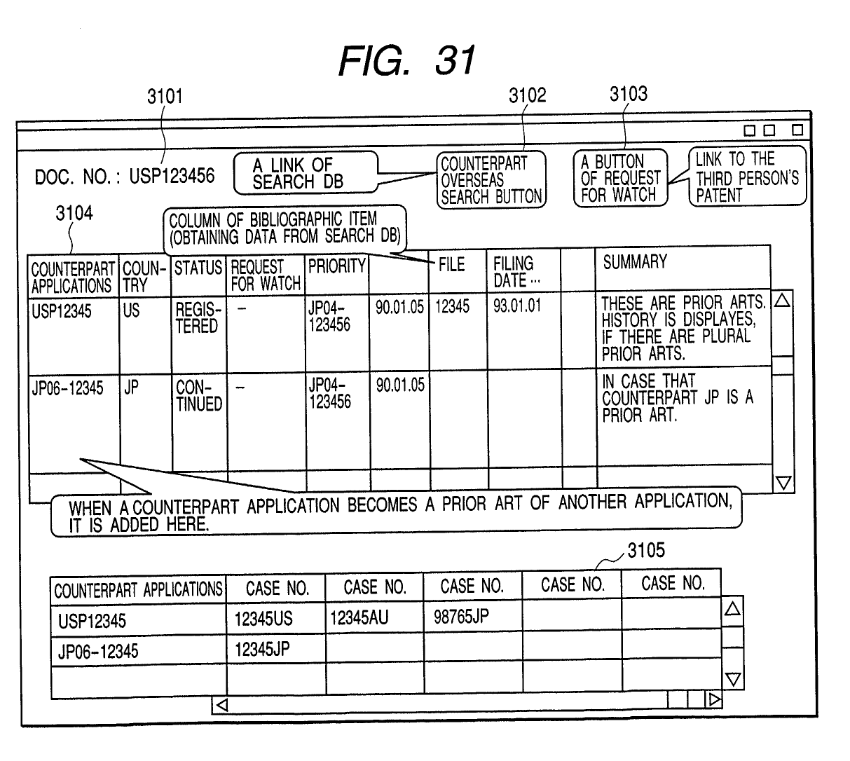

FIG. 31 shows a display screen for a reverse tracing by a document (type 2). Reference numeral 3101 denotes a document number. Reference numeral 3102 denotes a counterpart foreign application retrieval button. When it is pressed, a link to the patent retrieval DB of the server 118 is established, thereby inspecting a document of the family (for example, the US application, the Japanese application, etc.). Reference numeral 3103 denotes a button of request for an in-house procedure of automatically watching the condition (registration, deletion, or the like) of the document. Reference numeral 3104 denotes a list of the bibliographic information of the family of the document cited in any case. Reference numeral 3105 denotes a list of cases obtained by inversely tracing the case numbers by which documents are cited. For example, it is immediately indicated that ‘USP12345’ is a document cited by the case numbers ‘12345US’, ‘12345AU’, and ‘098765JP’.

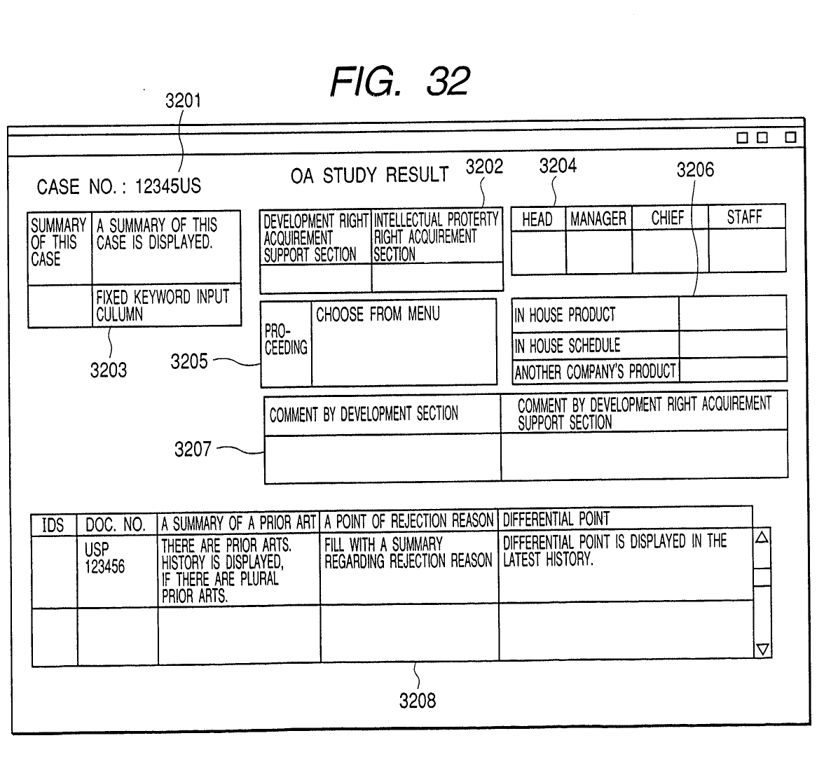

FIG. 32 shows the result (one history unit of one case) of the study of an office action processed in an action case.

Reference numeral 3201 denotes the case number of the present case. Reference numeral 3202 the names of the staffs in the development right acquirement support section and the intellectual property right acquirement section and their access addresses. Reference numeral 3203 denotes the summary of the present case. Reference numeral 3204 denotes an approval stamp. Reference numeral 3205 denotes the type of office action. Reference numeral 3206 denotes a product of the company, the execution plan of the company, and the products of other companies in which the invention of this case is implemented. Reference numeral 3207 denotes comments of the studying persons in the development section and the development right acquirement support section. Reference numeral 3208 denotes a list of the documents cited in the case. The list shows the items of a flag indicating whether or not the document has been disclosed by the prior art in US and CN, the summary of the cited document, the portion corresponding to the notice of reasons for rejection, and the differentiation point.

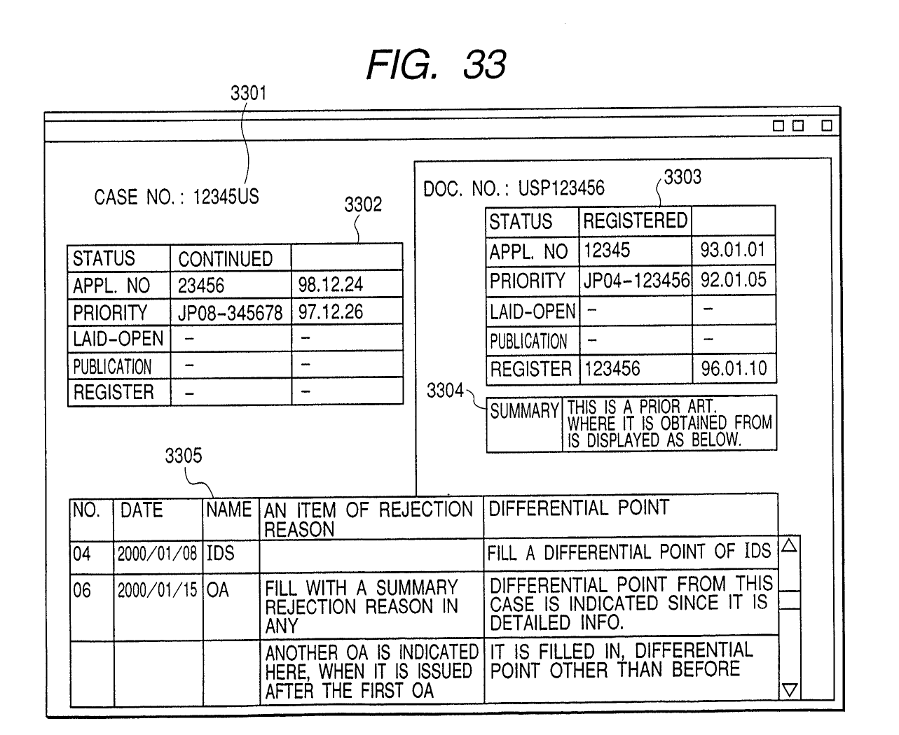

FIG. 33 shows the display screen of the related documents in each case unit. Reference numeral 3301 denotes a case number. Reference numeral 3302 denotes the current situation of the case number, the bibliographic items such as the application, laid-open, registration number, etc. Reference numeral 3303 denotes a bibliographic items of the related documents. Reference numeral 3304 denotes the summary of the document. Reference numeral 3305 denotes a list of the obtaining date of the document, an acquirement method, a counterpart portion of a rejection, a differentiation point, etc.

As described above, by having information about related documents for each application case and history, a document can be retrieved and displayed in case and history units, and a case can be retrieved and displayed in document units. As a result, the efficiency in performing a right acquiring process by studying a notice of reasons for rejection can be considerably improved. Especially when documents are managed in a paperless process in a network environment, a document database managed in case and history units is effective.

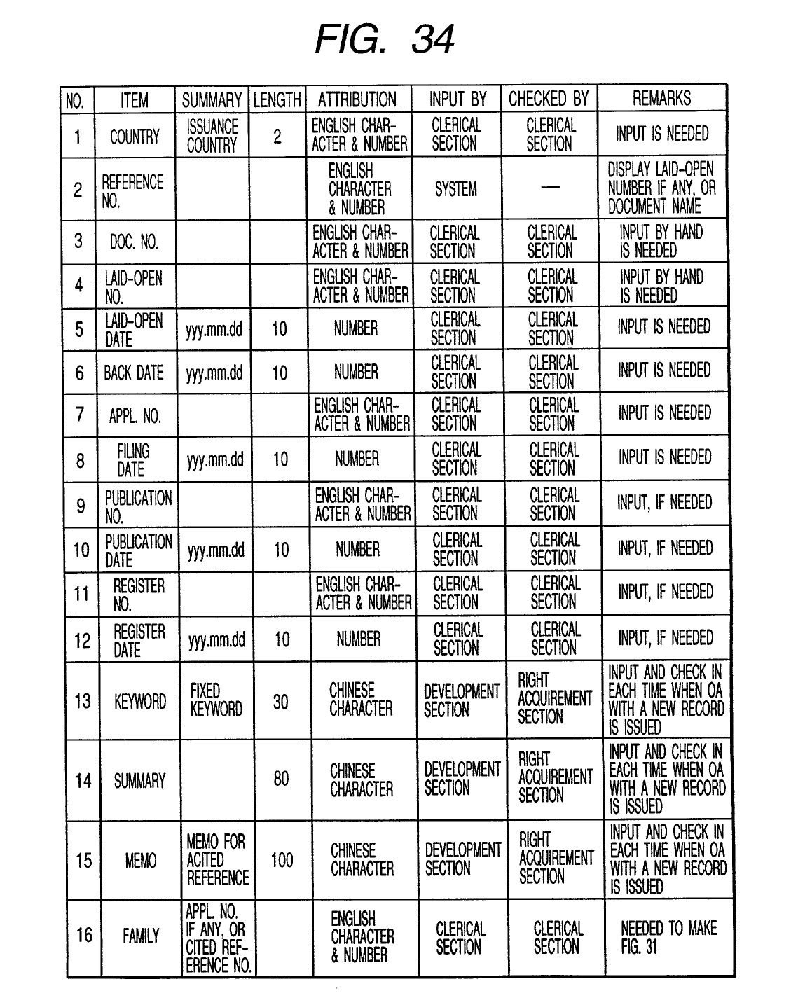

FIGS. 34 to 36 are tables for explanation of the definition of a DB management item used to set the above mentioned database.

FIG. 34 is a table showing the information managed for each document, and defines items of an issuance country, a reference number, a document number, a laid-open number, a laid-open date, a back date, an application number, a filing date, a publication number, a publication date, a register number, a register date, a keyword, a summary, a memo, and a family. For each item, a summary, a length, an attribute, a person who inputs the item, a checker, and a note are entered.

For example, the item name ‘issuance country’ refers to a country which issues the document, the length is two alphanumeric characters, a person who inputs items and a checker belong to the clerical section (intellectual property right acquirement support section), and the note indicates that data input is required. According to the rule, a document database is generated.

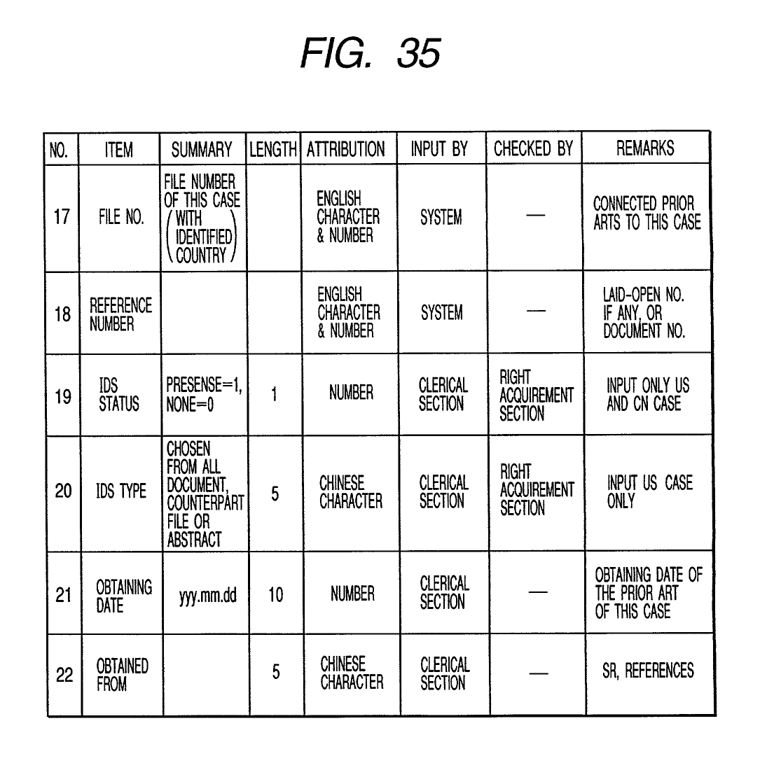

FIG. 35 is a table indicating the information for each case (corresponding to a case number), and defines items of File No., a reference number, an IDS status, an IDS type, an obtaining date, and a source. Each item is defined as in FIG. 34.

For example, the item ‘File No.’ can specify an issuance country, the attribute is an alphanumeric character, a person who inputs data refers to system automatic input, no checker is set, and the memo indicates the item connecting the prior art to this case.

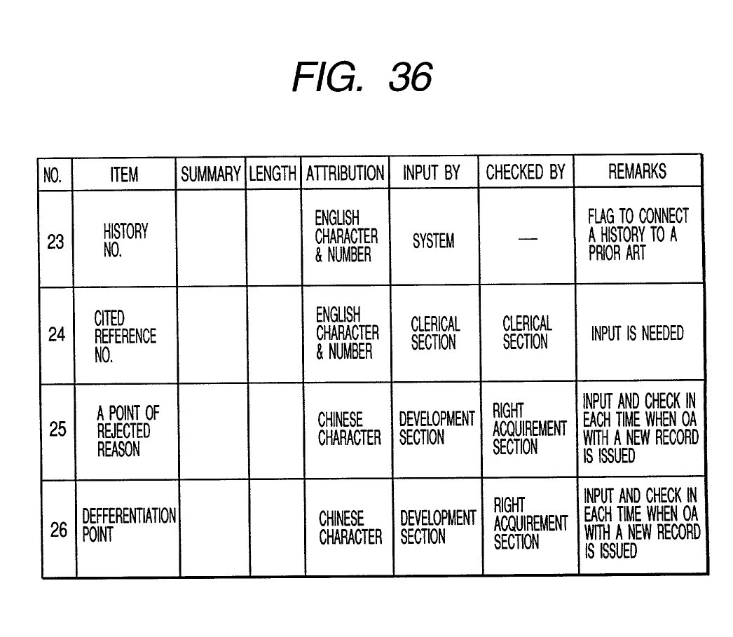

FIG. 36 contains the information for each reference of each history (for example, corresponding to the above mentioned action case) of each case (corresponding to a case number), and defines items of a history number, a reference number, a point of rejection, and a differentiation point. Each item is defined as in FIG. 34.

For example, for the item ‘reference number’, the attribute is an alphanumeric character, a person who input data and a checker belong to the clerical section, and the note indicates that data input is required.

By inputting the above defined items, the above mentioned DB management, retrieval, and display can be realized.

The present invention can also be attained by providing a storage medium storing a program code of software realizing the function of the above mentioned embodiments in a system or a device, and by the computer (or the CPU or the MPU) in the system or the device reading and executing the program code stored in the storage medium.

In this case, the program code itself read from the storage medium realizes the function of the above mentioned embodiments, and the storage medium storing the program code configures the present invention. The storage medium for providing a program code can be, for example, a floppy disk, a hard disk, an optical disk, a magneto-optical disk, CD-ROM, a CD-R, a magnetic tape, a non-volatile memory card, ROM, etc.

Furthermore, the functions according to the above mentioned embodiments can be realized not only by executing the program code read by the computer, but also by the OS (operating system), etc. operating in the computer performing all or a part of the actual process at an instruction of the program.

In addition, after a program code read from the storage medium has been written to the memory provided in an extension board and a function extension unit inserted to the computer, the CPU, etc. provided in the function extension board or the function extension unit performs all or a part of the actual process at an instruction of the program code, thereby realizing the functions of above mentioned embodiments.

Furthermore, the concepts of the work flow, the generation of a database, the configuration of a system, etc. in the above-described embodiments can be arbitrarily transformed and combined appropriately.

What is claimed is:

1. An information processing apparatus for studying a target case by communicating information through a network, comprising:
request means for requesting a first inspector to study the target case; and
detection means for detecting access to a database relating to the target case by the first inspector.

2. The apparatus according to claim 1, further comprising:
report means for reporting a detection result obtained by said detection means to a requester who has requested the first inspector to study the case.

3. The apparatus according to claim 2, wherein
said report means checks an access state by the first inspector at predetermined time intervals, and issues a predetermined reminder when no access is detected a predetermined time after the request.

4. The apparatus according to claim 1, further comprising:
suspension means for suspending a request from a requester who has requested the first inspector to study the case at an instruction of the requester.

5. The apparatus according to claim 4, further comprising:
re-request means for requesting a second inspector different from the first inspector at an inspection of the requester to accept a request of a requester who has requested the first inspector to study the case.

6. An information processing method for studying a target case by communicating information through a network, comprising the steps of:
requesting a first inspector to study the target case; and
detecting access to a database relating to the target case by the first inspector.

7. An program storage medium storing a program for realizing an information processing method for studying a target case by communicating information through a network, comprising:
a code for requesting a first inspector to study the target case; and
a code for detecting access to a database relating to the target case by the first inspector.

8. An information processing apparatus for studying a target case by communicating information through a network, comprising:
a table relating to organization information; and
management means for selectively performing by referring to said table a first study management mode in which the target case is studied through a predetermined path, and a second study management mode in which an inspector who inspects the target case sequentially requests a subsequent inspector to study the case.

9. The apparatus according to claim 8, wherein
said table relating to the organization information indicates a hierarchical management structure in a company.

10. The apparatus according to claim 8, further comprising:
a study path pattern table storing a plurality of patterns of study paths for the first study management mode.

11. The apparatus according to claim 8, wherein
in the second study management mode, a request for study is issued by specifying a name of an inspector without using said table relating to the organization information.

12. An information processing method for studying a target case by communicating information through a network, comprising the steps of:
referring to a table relating to organization information; and
performing a managing step by selectively performing based on said referring step a first study management mode in which the target case is studied through a predetermined path, and a second study management mode in which an inspector who inspects the target case sequentially requests a subsequent inspector to study the case.

13. A program storage medium storing a program for realizing an information processing method for studying a target case by communicating information through a network, comprising:
a code for referring to a table relating to organization information; and
a code for realizing a managing step by selectively performing based on said referring process a first study management mode in which the target case is studied through a predetermined path, and a second study management mode in which an inspector who inspects the target case sequentially requests a subsequent inspector to study the case.

14. An information processing apparatus for generating a document relating to a patent application by communicating information through a network, comprising:
association means for dividing a patent application procedure into a plurality of steps, and associating a reference document used in generating a document in step units with a due date of generation of the document; and
management means for managing generation of the document.

15. The apparatus according to claim 14, wherein
said plurality of steps contain an application and a rejection reason response.

16. The apparatus according to claim 14, wherein
said management means manages generation of the document by making links to a management database for item management and a document database for document management.

17. The apparatus according to claim 14, wherein
said management means manages generation of the document by defining a virtual file in a network.

18. The apparatus according to claim 17, wherein
a timing of generating a file is defined in said step units relating to the virtual file.

19. The apparatus according to claim 17, wherein
a process performed when a file is generated is defined in said step units relating the virtual file.

20. The apparatus according to claim 17, wherein
a timing of extinguishing a file is defined in said step units relating to the virtual file.

21. The apparatus according to claim 17, wherein
a process performed when a file is extinguished is defined in said step units relating the virtual file.

22. The apparatus according to claim 17, wherein
a related document is defined in said step units relating to the virtual file.

23. The apparatus according to claim 17, wherein
a study and approval path Is defined in said step units relating to the virtual file.

24. The apparatus according to claim 17, wherein
said virtual file can be copied, and simultaneously distributed through a network using a plurality of paths.

25. An information processing method for generating a document relating to a patent application by communicating information through a network, comprising the steps of:
dividing a patent application procedure into a plurality of steps, and associating a reference document used in generating a document in step units with a due date of generation of the document; and
managing generation of the document.

26. A program storage medium storing a program for realizing an information processing method for generating a document relating to a patent application by communicating information through a network, comprising the steps of:
a code for dividing a patent application procedure into a plurality of steps, and associating a reference document used in generating a document in step units with a due date of generation of the document; and
a code for realizing a managing step of managing generation of the document.

27. An information processing apparatus for accumulating technical documents relating to a patent application, comprising:
accumulation means for accumulating a related technical document including a corresponding foreign application for the patent application; and
display control means for displaying a list of technical documents of a patent application accumulated in said accumulation means.

28. The information processing apparatus according to claim 27, wherein
said display control means displays a flag indicating whether or not a prior art disclosure procedure has been performed on the technical document.

29. The information processing apparatus according to claim 27, wherein
said display control means displays descriptions indicating correspondence between the technical document and a rejection reason.

30. The information processing apparatus according to claim 27, wherein
said display control means displays a list of applications by which the technical document has been cited relating to the technical document.

31. An information processing method for accumulating technical documents relating to a patent application, comprising the steps of:
accumulating a related technical document including a corresponding foreign application for the patent application; and
displaying and controlling a list of technical documents of a patent application accumulated in said accumulation step.

32. A program storage medium storing a program for realizing an information processing method for accumulating technical documents relating to a patent application, comprising the steps of:
a code for realizing an accumulation step of accumulating a related technical document including a corresponding foreign application for the patent application; and
a code for realizing a displaying and controlling step of displaying a list of technical documents of a patent application accumulated in said accumulation step.
